(19) United States
(12) Patent Application Publication
(10) Pub. No.: US 2013/0226549 A1
(43) Pub. Date: Aug. 29, 2013

(54) STRUCTURE-BASED FRAGMENT HOPPING FOR LEAD OPTIMIZATION AND IMPROVEMENT IN SYNTHETIC ACCESSIBILITY

(71) Applicant: YUFENG J. TSENG, (US)

(72) Inventors: YUFENG J. TSENG, Taipei (TW); FANG-YU LIN, Taipei (TW)

(73) Assignee: YUFENG J. TSENG, Taipei (TW)

(21) Appl. No.: 13/778,858

(22) Filed: Feb. 27, 2013

Related U.S. Application Data
(60) Provisional application No. 61/603,501, filed on Feb. 27, 2012.

(51) Int. Cl. G06F 19/12

(52) U.S. Cl. CPC G06F 19/12
USPC 703/11

(57) ABSTRACT

The invention develops a computer-aided drug design method and system to optimize a lead through structure-based drug design with synthetic accessibility. In this invention, two systems of the structure-based lead optimization are developed and implemented: 1) LeadOp (“short for lead optimization”)—an algorithm that performs lead optimization through structure-based fragment hopping method; and 2) LeadOp+R (short for “lead optimization with synthetic accessibility based on chemical reaction route”)—an algorithm that performs lead optimization with synthetic accessibility. LeadOp algorithm provides users to optimize a lead compound with various combinations of fragments with stronger binding based on group efficiency, generating lead with stronger potency. Furthermore, LeadOp+R provides an advantage in the selection of the new fragment to be assembled, which was identified based on the group efficiency calculated in the active site and reaction rule.

### FIELD OF THE INVENTION

The present invention generally relates to computer-aided molecular design, and more specifically computer-aided lead optimization and computational modeling of lead optimization.

### BACKGROUND OF THE INVENTION

Discovering a new drug to treat or cure some biological condition, is a lengthy and expensive process, typically taking on average 12 years and $800 million per drug, and taking possibly up to 15 years or more and $1 billion to complete in some cases. Numerous software packages have been developed to assist in the development of new drugs. These methods involve a wide range of computational techniques, including use of a) rigid-body pattern-matching algorithms, either based on surface correlations, use of geometric hashing, pose clustering, or graph pattern-matching; b) fragmental-based methods, including incremental construction or ‘place and join’ operators; c) stochastic optimization methods including use of Monte Carlo, simulated annealing, or genetic (or memetic) algorithms; d) molecular dynamics simulations or e) hybrids strategies derived thereof.

Lead optimization typically involves substituent replacement paired with a QSAR (quantitative structure—activity relationship) model to refine and evaluate new compounds related to a specific biological end point or druglike properties. The use of QSAR optimization relies on the availability of confirmed chemical and biological data for a series of molecules to build the QSAR model that is able to predict the bioactivity (or end point) for new compounds in the hope of designing either better compounds or finding a novel series of compounds. Scaffold hopping aims to substitute the existing chemical core structure with a novel chemical structure while maintaining—or improving—the biological activity of the original molecule and uses one of two approaches: (i) virtual screening of the entire molecule, not a specific scaffold, to find novel chemical structures in molecular databases of available or virtual compounds or (ii) replacing the core structure with a different chemical motif that preserves similar ligand-receptor interactions via crucial ligand terminal groups.

The QSAR approach in the search for new scaffolds depends mostly on the molecular similarity of the initial compound of interest and the compounds in the database. The molecular similarity search techniques include shape, pharmacophore, and fingerprint-based methods or a combination of these strategies to identify similar molecules based on molecular features and potential similar bioactivities. The type of structural features and the molecular similarity cutoff value affects which molecules are selected. To overcome the molecular similarity bias that is commonly seen in ligand-based methods, fragment-based approaches have become widely used. Fragment libraries of possible molecular replacements (substituent) can be constructed by searching for bioisosteres, locating similar ring systems, replacing a central atom of the scaffold, using simple chemical rules (SMART matches, an extension of SMILES strings used to locate molecular substructures to condense the current compound databases), or defining fragmentation schemes of known ligands (Weininger, D. SMILES, A Chemical Language and Information System. 1. Introduction to Methodology and Encoding Rules. J. Chem. Inf. Comput. Sci. 1988, 28, 31-36; Lewell, X. Q.; Judd, D. B.; Watson, S. P.; Hann, M. M. RECAP—Retrosynthetic Combinatorial Analysis Procedure: A Powerful New Technique for Identifying Privileged Molecular Fragments with Useful Applications in Combinatorial Chemistry. J. Chem. Inf. Comput. Sci. 1998, 38, 511-522; and Fechner, U.; Schneider, G. Flux (2): Comparison of Molecular Mutation and Crossover Operators for Ligand-Based de Novo Design. J. Chem. Inf. Model. 2007, 47, 656-667).

Prior knowledge of the ligand-receptor interactions by means of a cocrystal structure allows the incorporation of these molecular interactions in the search for compounds with different core structures while preserving similar biological activity (Grant, M. A. Protein Structure Prediction in Structure-Based Ligand Design and Virtual Screening. Comb. Chem. High Throghput Screening 2009, 12, 940-960). Bergmann et al. combined the GRID19-based interaction profile of the target protein with the geometrical description of a ligand scaffold to obtain new scaffolds with discrete structural features (Bergmann, R.; Linusson, A.; Zamora, I. SHOP: Scaffold HOP-ping by GRID-Based Similarity Searches. J. Med. Chem. 2007, 50, 2708-2717).

Favorable regions for potential ligand-receptor interactions are identified through the creation (calculation) of isocontours. The molecular probes used to calculate the molecular interaction field isocontours include a water molecule, a methyl group, an amine nitrogen, a carboxyl oxygen, and a hydroxyl group. Each probe visits each grid point of a uniformly constructed grid that contains the receptor or a user-defined region of the receptor such as the binding site. Another methodology, GANDI, is fragment-based and generates new molecules by connecting predocked—to the receptor's binding site—fragments and linkers within the binding site (Dey, F.; Caflisch, A. Fragment-Based de Novo Ligand Design by Multiobjective Evolutionary Optimization. J. Chem. Inf. Model. 2008, 48, 679-690). Successive force-field-based (molecular mechanics) energy minimization of the new complex is carried-out to remove steric clashes and optimize the ligand-receptor interactions to mirror the 2D-similarity and 3D-overlap of the original compound's known binding mode(s) by way of a genetic algorithm. The GANDI protocol was assessed using the cyclin-dependent kinase 2 (CDK2) biomolecular system. New bioactive compounds for CDK2 were suggested that contained unique scaffolds and transformed substituents, which preserved the main binding motifs, along with corresponding to known CDK2 inhibitors.

A basic difficulty in most applications of computer-aided drug design is that designed (suggested) molecules are often of uncertain synthetic accessibility, leading to a slow feedback-improvement loop between the experimental syntheses and modeling design. Various synthetic planning software, WODCA, SYNGEN, and ROBIA, were developed to provide the synthetic route generation, that involves either searching a database of chemical reactions or transformation rules for reaction centers that match the target compound to propose analogous transformations (Ihlenfeldt, W.-D.; Gasteiger, J. Angew. Chem. Int. Ed. Engl. 1996, 34, 2613.; Hendrickson, J. B.; Toczko, A. G. Pure Appl. Chem. 1988, 60, 1563.; Socorro, I. M.; Goodman, J. M. J. Chem. Inf. Model. 2006, 46, 606). Tools in route generation, mostly retrosynthetic software, can suggest routes based on encoded generalized reaction rules to identify those bond disconnections most apt to lead to synthetically accessible precursor structures while Hendrickson's group developed a logic-based synthesis design method with formalized reaction constraints (Hendrickson, J. B.; Grier, D. L.; Toczko, A. G. J. Am. Chem. Soc. 1985, 107, 5228). A good example of route generation is Route Designer, that use rules describing retrosynthetic transformations automatically generated from reaction database and generates complete synthetic routes for target molecules starting from available reactants (Law, J.; Zsoldos, Z.; Simon, A.; Reid, D.; Liu, Y; Khew, S. Y; Johnson, A. P.; Major, S.; Wade, R. A.; Ando, H. Y J. Chem. Inf. Model. 2009, 49, 593). Softwares combining the synthetic route designing and de-novo design for the target binding sites have also been developed, such as SPROUT, which starts from generation of a skeleton followed by atom substitution to convert the solution skeletons to molecules and rank the output from SPROUT according to ease of synthesis (Mata, P.; Gillet, V. J.; Johnson, A. P.; Lampreia, J.; Myatt G. J.; Sike, S.; Stebbings, A. J. Chem. Inf. Comput. Sci., 1995, 35, 479). However, the molecules are generated from the ease of synthesis, the desired core of potential inhibitors could not be easily preserved.

Therefore, there is a need for improved systems and methods to optimize a lead compound with greater accuracy.

### SUMMARY OF THE INVENTION

One object of the invention is to provide a method for optimizing a lead compound, comprising:
(i) docking a lead compound into a target molecule to obtain the information of the lead compound and its binding site;
(ii) decomposing the docked lead compound of (i) to form fragments;
(iii) evaluating the fragments of (ii) on the basis of group efficiency or synthetic accessibility to determine the fragments to be preserved and replaced; and
(iv) reassembling the preserved fragments and the replaced fragments of (iii) to construct the optimized lead compound library.
   and a system for carrying out the method.

Another object of the invention is to provide a method for optimizing a lead compound, comprising:
(a) docking a lead compound into a target molecule to obtain the information of the lead compound and its binding site;
(b) decomposing the docked lead compound to form fragments;
(c) evaluating each fragment of (b) with the degree of interaction based on group efficiency and then ranking them;
(d) searching for a library to obtain potential replacement fragments and predocking each fragment into the binding site of the target molecule to obtain the replacement fragments;
(e) preserving the top 50% fragments of the ranked fragments of (c) and replacing reminder fragments with the substitution fragments of (d); and
(f) reassembling the preserved fragments and the replaced fragments to construct the optimized lead compound library.
   and a system for carrying out the method.

A further object of the invention is to provide a method for lead optimization with synthetic accessibility, comprises:
(A) docking a lead compound into a target molecule to obtain the information of the lead compound and its binding site;
(B) decomposing the docked lead compound to form fragments and determining fragments to be preserved;
(C) identifying the first building block containing preserved fragments of the lead compound,
(D) identifying reactants and searching for the reaction rules for each reactants identified from a reaction rule library;
(E) reacting reactants to generate reaction products based on their reaction rules; and
(F) evaluating the conformations of each products of each reaction and selecting the conformers to react with the first building block to grow molecules so that an optimized lead compound library is constructed.
   and a system for carrying out the method.

### BRIEF DESCRIPTION OF THE DRAWING

FIG. 1 provides an example illustrating an embodiment of the system of the present invention for optimizing a lead compound.

FIG. 2 provides an example illustrating a preferred embodiment of the system of the present invention for optimizing a lead compound.

FIG. 3 provides an example illustrating a preferred embodiment of the system of the present invention for optimizing a lead compound with synthetic accessibility.

FIG. 4 shows a scheme illustrating the LeadOp optimization steps. Starting with a query molecule in its binding pose at the active site, it is decomposed into fragments. The molecular fragments are evaluated and those with the least amount of contribution to binding, based on group efficiency, are replaced with a fragment database through an evaluation process, while the remaining parts were preserved. New compounds are generated by linking the fragments, and the newly proposed compounds are ranked on the basis of a calculated binding free energy.

FIG. 5 shows the ligand-protein interaction of mutant B-Raf and LIE from cocrystal structure (PDB ID: 3idp) Chemical characteristic of each residue and interaction within the complex are colored and described in the following.

FIG. 6 shows LeadOp result in B-Raf model system: (a) Each fragment of compound A is colored differently (left). The red ovals indicated the fragments selected to be replaced (right). (b) The carbon atoms of the original compound A are colored yellow and the new fragments' carbon atoms, of the generated compound (middle), are colored red (left). Amino acid residues that participate in hydrogen-bonding interactions with the proposed compound, at the binding site (right), are depicted with cyan molecular surfaces.

FIG. 7 shows Schematic representation of the human 5-LOX active site (left) and the binding pocket (right). The perceived pharmacophores of the binding site of 5-LOX involve two hydrophobic groups (blue ovals), two hydrogen-bond acceptors (green ovals), and an aromatic ring (orange oval) for ligand binding at the binding cavity.

FIG. 8 shows LeadOp result in 5-LOX model system: (a) Each fragment of compound F is colored differently (left). The red ovals indicated the fragments selected to be replaced (right). (b) The original compound F carbon atoms are colored yellow and the new fragments' carbon atoms, of the generated compound (middle), are colored red (left). Amino acid residues that participate in hydrogen-bonding interactions with the proposed compound, at the binding site, (right) are depicted with cyan molecular surfaces.

FIG. 9 shows a scheme illustrating the LeadOp+R optimization workflow.

FIG. 10 shows an example of three steps used to construct the table of reaction rules. (a) Identification of reaction cores. The atoms with changed atom attributes are highlighted in red and blue within the two reactants. (b) Extraction of the moieties. (c) Identification of building blocks containing the reactant moieties. (d) Illustration of the steps in generating products. One reaction rule consists of reactant moiety(s) and product moiety(s). In this reaction example, where reactant A is reacting with reactant B, both reactant A and B contain the matched reactant moiety, while reactant B also contains a leaving group that is part of the product moiety. The structure excluding the reactant moiety in reactant A is denoted as the “clipped reactant”, which is added to the product moieties (product and leaving group).

FIG. 11 shows evaluation of each product for each reaction. Thirty conformers are generated (colored in yellow, green, orange, and gray sticks) and overlaid with the reactant within the binding site (colored in red stick). The user-defined inhibitor-receptor interaction direction (location) is indicated by the dotted red line.

FIG. 12 shows LeadOp+R result for the Tie-2 model system. (a) Chemical characteristic of each residue and interaction within the complex of compound 47 from the co-crystal structure (PDB code: 2p4i). (b-d) Chemical structure (left) and MDS result (right) of the generated compound rA1 (b), the generated compound rA2 (c), and the generated compound rA3 (d). Carbon atoms are colored pink. Amino acid residues that participate in hydrogen-bonding interactions (labeled red) with the proposed compound at the binding site are depicted with cyan molecular surface.

FIG. 13 shows synthetic routes for compound rA1. (a) Synthetic routes with reagents and condition (a-d) from experimental studies.¹⁶ (b) Synthetic routes and (c) matched reaction rules provided by LeadOp+R from sub-structure searching to identify atom arrangements (moieties) that are part of a chemical reaction rule within the LeadOp+R reaction database.

FIG. 14 shows synthetic routes for compound rA2. (a) Synthetic routes with reagents and condition (a-g) from experimental studies. (b) Synthetic routes and (c) matched reaction rules provided by LeadOp+R from sub-structure searching to identify atom arrangements (moieties) that are part of a chemical reaction rule within the LeadOp+R reaction database.

FIG. 15 shows synthetic routes for compound rA3. (a) Synthetic routes with reagents and condition (a-f) from experimental studies.¹⁶ (b) Synthetic routes and (c) matched reaction rules provided by LeadOp+R from sub-structure searching to identify atom arrangements (moieties) that are part of a chemical reaction rule within the LeadOp+R reaction database.

FIG. 16 shows LeadOp+R result for the 5-LOX kinase model system. (a) Schematic representation of the human 5-LOX active site (left) and the binding pocket (right). The purported pharmacophores of the binding site of 5-LOX involving two hydrophobic groups (blue ovals), two hydrogen bond acceptors (green ovals), and an aromatic ring (orange oval) for ligand binding at the binding cavity. (b-d) Chemical structure (left) and MDS result (right) of the generated compound rB1 (a), the generated compound rB2 (b), and the generated compound rB3 (c). Carbon atoms are colored pink Amino acid residues that participate in hydrogen-bonding interactions (labeled red) with the proposed compound within the binding site are depicted with gray molecular surfaces.

FIG. 17 shows synthetic routes for compound rB1 (a) Synthetic routes with reagents and condition (a-c) from experimental studies.¹⁷ (b) Synthetic routes and (c) matched reaction rules provided by LeadOp+R from sub-structure searching to identify atom arrangements (moieties) that are part of a chemical reaction rule within the LeadOp+R reaction database.

FIG. 18 shows synthetic routes for compound rB2 (a) Synthetic routes with reagents and condition (a-e) from experimental studies. (b) Synthetic routes and (c) matched reaction rules provided by LeadOp+R from sub-structure searching to identify atom arrangements (moieties) that are part of a chemical reaction rule within the LeadOp+R reaction database.

FIG. 19 shows synthetic routes for compound rB3. (a) Synthetic routes with reagents and condition (a-d) from experimental studies. (b) Synthetic routes and (c) matched reaction rules provided by LeadOp+R from sub-structure searching to identify atom arrangements (moieties) that are part of a chemical reaction rule within the LeadOp+R reaction database.

### DETAILED DESCRIPTION OF THE INVENTION

The present invention has many applications, as will be apparent after reading this disclosure. In describing an embodiment of a system according to the present invention, only a few of the possible variations are described. Other applications and variations will be apparent to one of ordinary skill in the art, so the invention should not be construed as narrowly as the examples, but rather in accordance with the appended claims. Embodiments of the invention will now be described, by way of example, not limitation. It is to be understood that the invention is of broad utility and may be used in many different contexts.

The invention develops a computer-aided drug design method and system to optimize a lead through structure-based drug design with synthetic accessibility. In this invention, two systems of the structure-based lead optimization are developed and implemented: 1) LeadOp (“short for lead optimization”)—an algorithm that performs lead optimization through structure-based fragment hopping method; and 2) LeadOp+R (short for “lead optimization with synthetic accessibility based on chemical reaction route”)—an algorithm that performs lead optimization with synthetic accessibility. LeadOp algorithm provides users to optimize a lead compound with various combinations of fragments with stronger binding based on group efficiency, generating lead with stronger potency. Furthermore, LeadOp+R provides an advantage in the selection of the new fragment to be assembled, which was identified based on the group efficiency calculated in the active site and reaction rule.

As used herein, the term “binding” is a physical event in which a ligand is associated with a receptor site in a stable configuration

As used herein, the term “docking” is a computational procedure whose goal is to determine the configuration that will permit binding

As used herein, the term “structure-based drug design” is meant to refer to a process of dynamically forming a molecule or ligand which is conducive to binding with a particular receptor site using knowledge of the protein structure.

As used herein, the term “ligand” is a molecule that will bind with a receptor at a specific site.

As used herein, the term “molecule” is a structure true that can be formed based on the proposed receptor site.

### Methods and Systems for Structure-based Lead Optimization

In one aspect, the invention provides a method for optimizing a lead compound, comprising:
(i) docking a lead compound into a target molecule to obtain the information of the lead compound and its binding site;
(ii) decomposing the docked lead compound of (i) to form fragments;
(iii) evaluating the fragments of (ii) on the basis of group efficiency or synthetic accessibility to determine the fragments to be preserved and replaced; and
(iv) reassembling the preserved fragments and the replaced fragments of (iii) to construct the optimized lead compound library.

In another aspect, the invention provides a system for lead optimization, comprising a docking unit for docking a lead compound into a target molecule to obtain the information of the lead compound and its binding site; a decomposition unit for decomposing the docked lead compound to form fragments; an evaluation unit for evaluating the fragments on the basis of group efficiency or synthetic accessibility to determine the fragments to be preserved and replaced; and a reassemble unit for reassembling the preserved fragments and the replaced fragments to construct the optimized lead compound library.

In one embodiment, after the decomposition step, the method of the invention further comprises (B1) determining lead compound-target molecule interaction directions to be optimized, and the system of the invention further comprises a determination unit for determining lead compound-target molecule interaction directions to be optimized.

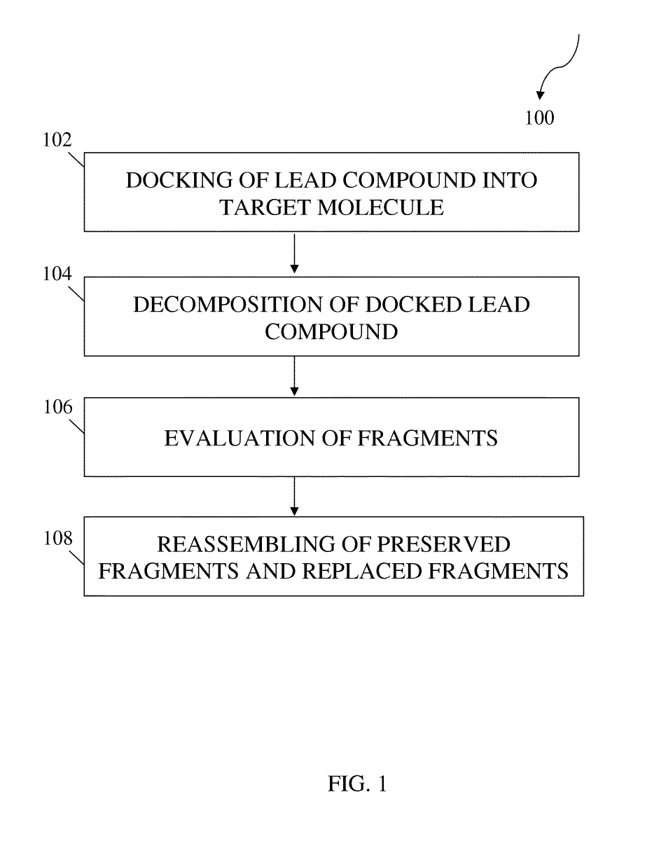

Referring to FIG. 1, generally at 100, the novel method that the system of the present invention uses for optimizing a lead compound, as shown. In FIG. 1, at 102, information regarding the lead compound and its binding site is provided. At 104, the docked lead compound is decomposed to obtain fragments. In one embodiment, the decomposition is performed by chemical or user-defined rules. At 106, the decomposed fragments are evaluated with group efficiency or synthetic accessibility to determine the fragments to be preserved and replaced. At 108, the preserved fragments and replaced fragments are reassembled to for optimized lead compound.

### Methods and Systems for Structure-based Lead Optimization—LeadOp Embodiment

In one aspect, the present invention provides a method for optimizing a lead compound, comprising:
(a) docking a lead compound into a target molecule to obtain the information of the lead compound and its binding site;
(b) decomposing the docked lead compound to form fragments;
(c) evaluating each fragment of (b) with the degree of interaction based on group efficiency and then ranking them;
(d) searching for a library to obtain potential replacement fragments and predocking each fragment into the binding site of the target molecule to obtain the replacement fragments;
(e) preserving the top 50% fragments of the ranked fragments of (c) and replacing reminder fragments with the substitution fragments of (d); and
(f) reassembling the preserved fragments and the replaced fragments to construct the optimized lead compound library.

In another aspect, the invention provides a system for lead optimization, comprising (i) a docking unit for docking a lead compound into a target molecule to obtain the information of the lead compound and its binding site; (ii) a decomposition unit for decomposing the docked lead compound to form fragments; (iii) an evaluation unit for evaluating each fragment of (ii) with the degree of interaction based on group efficiency and then ranking them; (iv) a predocking unit for searching for a library to obtain of potential replacement fragments and predocking each fragment into the binding site of the target molecule to obtain the replacement fragments; (v) a preserving and replacing unit for preserving the top 50% fragments of the ranked fragments of (iii) and replacing reminder fragments with the substitution fragments of (iv); and (vi) a reassembling unit for reassembling the preserved fragments and the replaced fragments to construct the optimized lead compound.

In one embodiment, after the decomposition step, the method of the invention further comprises (b1) determining lead compound-target molecule interaction directions to be optimized, and the system of the invention further comprises a determination unit for determining lead compound-target molecule interaction directions to be optimized.

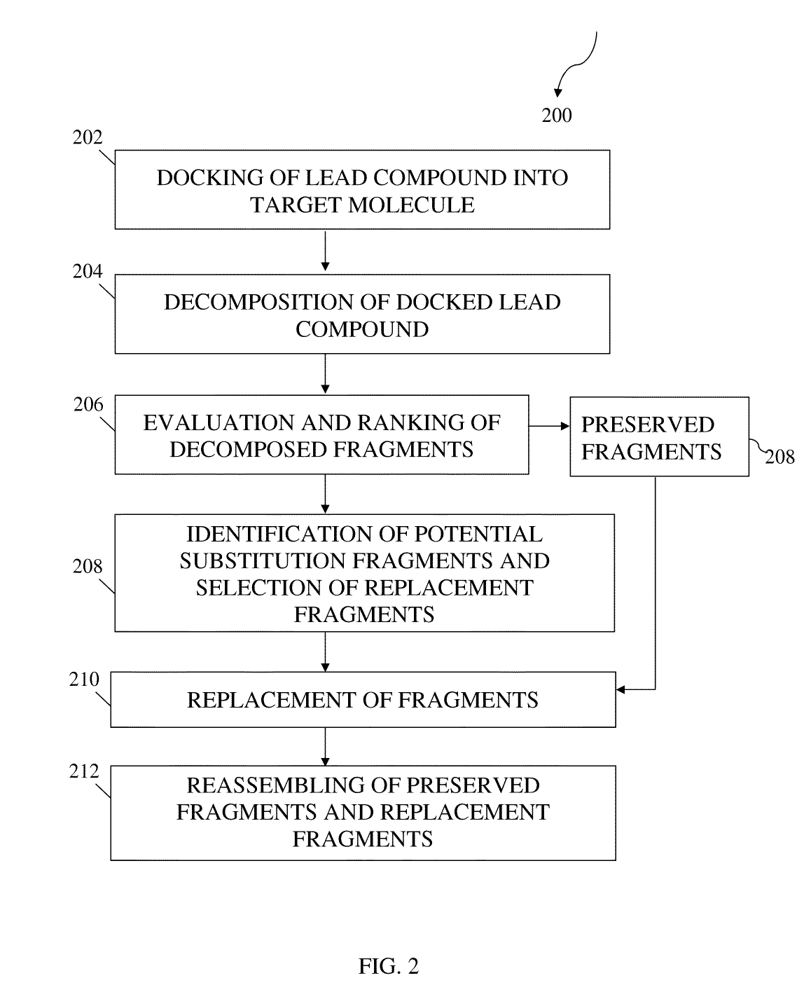

Referring to FIG. 2, generally at 200, the novel method that the system of the present invention uses for optimizing a lead compound, as shown. In FIG. 2, at 202, information regarding the lead compound and its binding site is provided. At 204, the docked lead compound is decomposed to obtain fragments. In one embodiment, the decomposition is performed by chemical or user-defined rules.

At 206, the decomposed fragments are evaluated with the degree of interaction based on group efficiency and then these fragments are ranked. The calculation of group efficiency is known in the art; for example, that described in Marcel L. Verdonk and David C. Rees, ChemMedChem 2008, 3, 1179-1180. The interaction may be a physical or chemical interaction of one or more molecular subsets with itself (intramolecular) or other molecular subsets (intermolecular). Interaction may be either enthalpic or entropic in nature and may reflect either nonbonded or bonded interactions. The group efficiency of each fragment is calculated for ranking. The fragments possessing an unfavorable interaction with the target molecule are marked for replacement while those with more favorable interactions are preserved (shown in 208). In one embodiment, about top 50% fragments of the ranked fragments are preserved. More preferably, about top 40% fragments of the ranked fragments are preserved; more preferably, about top 30% and more preferably, about top 20%.

The library of potential substitution fragments at 210 is generated by decomposing a plurality of molecules in at least one database. Preferably, the database is the DrugBank database or SciFinder. For example, a number of molecules from the “small molecule structures” property descriptions of the “drug structure” section in the Drugbank database and the DrugBank compounds are energy-minimized and subsequently decomposed by DAIM to generate the fragments. The fragments are then predocked into the binding site of the target molecule by calculating the desolvation energy to obtain the replacement fragments. In one embodiment, acceptable bond distance(s) and angle(s) between the fragments and the original lead compounds attachment points are used to determine if the docked fragment should be a possible replacement.

At 212, the new lead compounds are generated by reassembling all the possible combinations of the preserved fragments at 208 and the substitution fragment at 210 to construct the optimized lead compound library. In one embodiment, the reassembling is based on appropriate bond lengths and angles.

In one embodiment of the invention, the method can further comprise trimming the optimized lead compound library to remove those that violate Lipinski's rules-of-five. Preferably, compounds with (i) four or more double bonds (excluding aromatic bonds) or triple bonds with no more than three of each type or (ii) 11 or more triple bond are removed from the potential set of compounds. Accordingly, a trimming unit for trimming the optimized lead compound library is provided for the system of the invention.

In another embodiment, in addition to the trimming step, the method can comprises performing molecular dynamics simulations. A unit for molecular dynamics simulations can also be provided for the system of the invention. In principle, molecular dynamics simulations may be able to model protein flexibility to an arbitrary degree. In the molecular dynamics simulation, energy parameters are generally associated with constituent atoms, bonds, and/or chemical groups to represent a particular physical or chemical attribute in the context of the calculation of one or more standard energy components. Assignment of an energy parameter may depend solely on the chemical identity of one or more atom or bonds involved in a given interaction and/or on the location of the atom(s) or bond(s) within the context of a chemical group, a molecular substructure such as an amino acid in a polypeptide, a secondary structure such as an alpha helix or a beta sheet in a protein, or of the molecule as a whole.

Methods and Systems for Structure-Based Lead Optimization with Synthetic Accessibility—LeadOp+R Embodiment

“LeadOp+R” is developed to consider the synthetic accessibility while optimizing leads. LeadOp+R first allows user to identify a preserved space defined by the volume occupied by a fragment of the query molecule to be preserved. Then LeadOp+R searches for building blocks with the same preserved space as initial reactants and grows molecules towards the preferred receptor-ligand interactions according to reaction rules from reaction database in LeadOp+R. Multiple conformers of each intermediate product were considered and evaluated at each step. The conformer with the best group efficiency score would be selected as the initial conformer of the next building block until the program finished optimization for all selected receptor-ligand interactions.

Accordingly, in a further aspect, the invention provides a method for lead optimization with synthetic accessibility, comprises:
(A) docking a lead compound into a target molecule to obtain the information of the lead compound and its binding site;
(B) decomposing the docked lead compound to form fragments and determining fragments to be preserved;
(C) identifying the first building block containing preserved fragments of the lead compound,
(D) identifying reactants and searching for the reaction rules for each reactants identified from a reaction rule library;
(E) reacting reactants to generate reaction products based on their reaction rules; and
(F) evaluating the conformations of each products of each reaction and selecting the conformers to react with the first building block to grow molecules so that an optimized lead compound library is constructed.

In another aspect, the invention provides a system for lead optimization with synthetic accessibility, comprising (i) a docking unit for docking a lead compound into a target molecule to obtain the information of the lead compound and its binding site; (ii) a decomposition unit for decomposing the docked lead compound to form fragments and determining fragments to be preserved; (iii) a first identification unit for identifying the first building block containing preserved fragments of the lead compound; (iv) a second identification unit for identifying reactants and searching for the reaction rules for each reactants identified from a reaction rule library; (v) an reaction unit for reacting reactants to generate reaction products based on their reaction rules; and (vi) an evaluation unit for evaluating the conformations of each products of each reaction and selecting the conformers to react with the first building block to grow molecules so that a optimized lead compound library is constructed.

In one embodiment, after the decomposition step, the method of the invention further comprises (B1) determining lead compound-target molecule interaction directions to be optimized, and the system of the invention further comprises a determination unit for determining lead compound-target molecule interaction directions to be optimized.

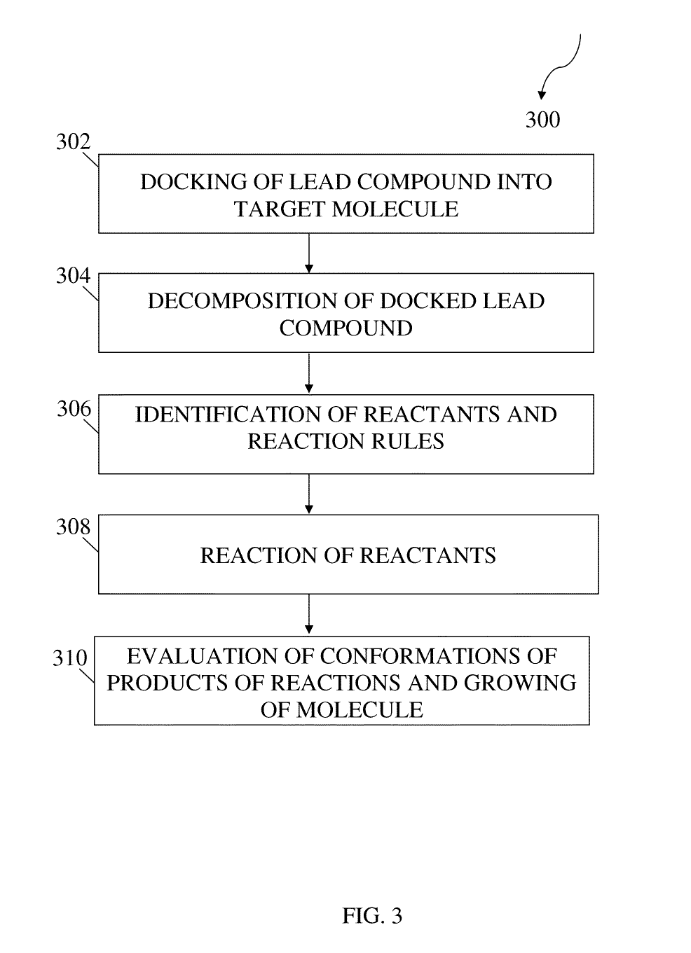

Referring to FIG. 3, generally at 300, the novel method that the system of the present invention uses for optimizing a lead compound based on synthetic accessibility, as shown. In FIG. 3, at 302, information regarding the lead compound and its binding site is provided. At 304, the docked lead compound is decomposed to obtain fragments. In one embodiment, the decomposition is performed by chemical or user-defined rules.

At 306, the building block containing the preserved fragment of the lead compound is used as the initial building block. In one embodiment, the initial step of the method of the invention requires the user to select the favored lead compound-target molecule interaction positions for optimization. The lead compound-target molecule interaction positions determine the “direction” for virtual synthesis and optimizations. The method of the invention will systematically optimize and grow a structure until all the user-defined directions are processed. The method of the invention initiates the analysis with the complex structure of lead compound-target molecule from docking studies. The user can determine which fragment(s) in the query inhibitor (initial compound) to preserve during optimization.

At 308, reactants and their reaction rules are identified on the basis of a reaction rule library. According to the invention, the reaction rule library is constructed by collecting chemical reactions, building blocks, and reaction rules with reactant moieties and product moieties of each reaction. For example, the building blocks include the typical building blocks in a chemical synthesis such as various nitrogen compounds (amines, isocyanides) and carbonyl compounds (amides, aldehydes, and ketones) and the reaction rule includes the reactant moieties and product moieties extracted from the full structure of reactants and products of each reaction collected. In one embodiment, the reaction moieties were defined and extracted from a chemical reaction according identification of reaction core and extraction of the reactant and product moieties for a reaction. The building blocks with the same reactant moiety for each reaction rule are collected and classified by the reaction. Building blocks for each reaction rule are recorded and used for virtual synthesis.

Subsequently, at 308, the reactants are identified by preserving a space called the “fragment space” that is defined by the volume occupied by a fragment of the lead compound. Then, building blocks with the same volume are searched as the potential initial reactants. The reaction rules for each reactant identified are then determined. When a reactant is identified, there are many potential reactant moieties and reactions associated with this reactant. Each reactant is subjected to sub-structure searching to identify atom arrangements (moieties) that are part of a chemical reaction rule within the reaction rule library to determine potential chemical reactions for this specific reactant.

At 310, reactants identified at 308 are reacted to generate reaction products based on their reaction rules. Once all the potential reaction rules of a reactant are identified, the corresponding products are generated by “reacting” the reactant moieties and participant reactants. In the method of the invention, each reactant has two parts: one structure matches the reactant moiety and the other structure—excluding the reactant moiety—is denoted as the “clipped reactant”. The same definition is used for other building blocks (participants) involved in a reaction. Each product is generated by combining the clipped portion of the reactant and the clipped portion of the participants as well as the product moiety based on the search of the reaction rule.

At 312, the conformations of each products of each reaction are evaluated and the conformers to react with the first building block are selected to grow molecules so that an optimized lead compound library is constructed. Multiple conformers of each intermediate product were considered and evaluated at each step. The conformer with the best group efficiency score would be selected as the initial conformer of the next building block until the program reached the termination condition. This evaluation would favor the conformers with stronger binding towards the specified lead compound-target molecule interactions with less heavy atoms. The compounds that passed the molecular property filters comprised the final list of proposed compounds. The compounds were then energy-minimized and ranked on the basis of the overall lead compound-target molecule binding energy.

In one embodiment of the invention, the method can further comprise trimming the optimized lead compound library to remove those that violate Lipinski's rules-of-five. Preferably, compounds with (i) four or more double bonds (excluding aromatic bonds) or triple bonds with no more than three of each type or (ii) 11 or more triple bond are removed from the potential set of compounds. Accordingly, a trimming unit for trimming the optimized lead compound library is provided for the system of the invention.

In another embodiment, in addition to the trimming step, the method can comprises performing molecular dynamics simulations. A unit for molecular dynamics simulations can also be provided for the system of the invention. In principle, molecular dynamics simulations may be able to model protein flexibility to an arbitrary degree. In the molecular dynamics simulation, energy parameters are generally associated with constituent atoms, bonds, and/or chemical groups to represent a particular physical or chemical attribute in the context of the calculation of one or more standard energy components. Assignment of an energy parameter may depend solely on the chemical identity of one or more atom or bonds involved in a given interaction and/or on the location of the atom(s) or bond(s) within the context of a chemical group, a molecular substructure such as an amino acid in a polypeptide, a secondary structure such as an alpha helix or a beta sheet in a protein, or of the molecule as a whole.

According to the invention, a target molecule in the above-mentioned methods and systems of the invention is a biomolecule, part of a biomolecule, compound of one or more biomolecules or other bioreactive agent, often a biopolymer, for which there is a desire to modify its actions in its environment. For example, biopolymers, including proteins, polypeptides, and nucleic acids, are example targets. Modification of actions of the target might include deactivating actions of the target (inhibition), enhancing the actions of the target or otherwise modifying its action before or during other interactions (catalysis). In one embodiment, the target molecule might be a protein that is produced or introduced into the human body and causes disease or other ill effect and the desired modification is to inhibit the action of the protein by competitively binding a small biomolecule to the relevant active site of the protein. In another embodiment, the target protein itself is not a direct initiator of the undesired disease or ill effect, but by affecting its function may better regulate reactions involving some other protein (e.g., enzyme, antibody, etc.) or biomolecule and thereby alleviate the condition warranting treatment.

According to the invention, a lead compound in the above-mentioned methods and systems of the invention is a biomolecule, part of a biomolecule, compound of one or more biomolecules or other bioreactive agent that has been selected based on prior assessment of relevant bioactivity with the target molecule. Preferably, the lead compound has a molecule weight less than 500 kDa. Examples of lead compounds include small molecule ligands, peptides, proteins, parts of proteins, synthetic compounds, natural compounds, organic molecules, carbohydrates, residues, inorganic molecules, ions, individual atoms, radicals, and other chemically active items. Lead compounds can form the basis of drugs or compounds that are administered or used to create desired modifications or used to examine or test for undesirable modifications. The terms “lead” is used interchangeably with the term “lead compound.

According to the invention, any of the methods and systems of the invention can be used in any computing or recording system, such as a computer program product or a storage media device.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

### EXAMPLE

### I. Lead Optimization Using LeadOp

### Materials and Methods for LeadOp

Overall Procedure.

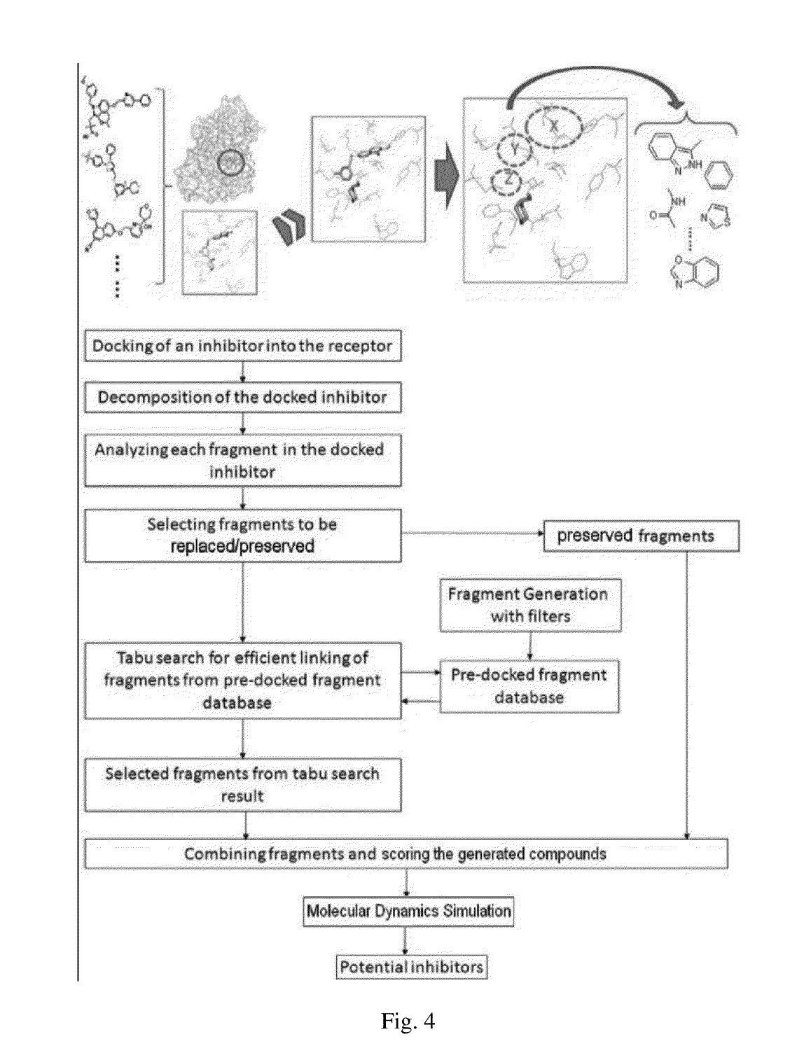

The overall protocol for LeadOp is illustrated in FIG. 4 and the details of each step are described in the following sections. The molecule to be modified is docked to the receptor's known drug binding site and then decomposed into molecular fragments. Each fragment of the query ligand was evaluated with the degree of interaction based on group efficiency or user-defined/scientific knowledge to determine which fragments were to be replaced. Molecular fragments of the ligand that possess an unfavorable interaction with the receptor, based on the initial evaluation, are marked for replacement while those with more favorable interactions are retained. Before the substitution of ligand fragments, a fragment library (consisting of fragments from the initial ligand and the DrugBank database) was constructed and predocked into the receptor's binding site (Wishart, D. S.; Knox, C.; Guo, A. C.; Cheng, D.; Shrivastava, S.; Tzur, D.; Gautam, B.; Hassanali, M. DrugBank: A Knowledgebase for Drugs, Drug Actions and Drug Targets. Nucleic Acids Res. 2008, 36, D901-D906). All predocked fragments are sorted (ranked) by their group efficiency—and ligand attachment point—creating a predocked fragment database used to draw potential ligand-fragment replacements for the noted ligand fragments possessing unfavorable interactions with the receptor. Tabu searching (Glover, F. Future Paths for Integer Programming and Links to Artificial Intelligence. Comput. Oper. Res. 1986, 13, 533-549) was implemented to search for the “superior” substituent from the predocked database. Once an optimal set of fragments for substitution was found, fragments are linked with the remaining portion of the initial molecule to generate a new compound. Finally, all the compounds generated with this strategy were ranked, providing a series of new de novo compounds.

Example Systems.

B-Raf kinase (PDB ID: 3idp), a ras-activated proto-oncogene serine/theronione protein kinase (Smith, A. L.; DeMorin, F. F.; Paras, N. A.; Huang, Q.; Petkus, J. K.; Doherty, E. M.; Nixey, T.; Kim, J. L.; Whittington, D. A.; Epstein, L. F.; Lee, M. R.; Rose, M. J.; Babij, C.; Fernando, M.; Hess, K; Le, Q.; Beltran, P.; Carnahan, J. Selective Inhibitors of the Mutant B-Raf Pathway: Discovery of a Potent and Orally Bioavailable Aminoisoquinoline. J. Med. Chem. 2009, 52, 6189-6192), and human 5-LOX enzyme (obtained from the homology model by Caroline et al., (Charlier, C.; Henichart, J.-P.; Durant, F.; Wouters, J. Structural Insights into Human 5-Lipoxygenase Inhibition: Combined Ligand-Based and Target-Based Approach. J. Med. Chem. 2006, 49, 186-195), a key enzyme in leukotriene biosynthesis, were selected as our model systems to examine the LeadOp approach. One B-Raf kinase inhibitor, compound 16 (aminoisoquinoline series) in Smith, A. L.; DeMorin, F. F.; Paras, N. A.; Huang, Q.; Petkus, J. K; Doherty, E. M.; Nixey, T.; Kim, J. L.; Whittington, D. A.; Epstein, L F.; Lee, M. R.; Rose, M. J.; Babij, C.; Fernando, M.; Hess, K; Le, Q.; Beltran, P.; Carnahan, J. Selective Inhibitors of the Mutant B-Raf Pathway: Discovery of a Potent and Orally Bioavailable Aminoisoquinoline. J. Med. Chem. 2009, 52, 6189-6192 (denoted as compound A in LeadOp study), and a human 5-LOX inhibitor, compound 7 (substituted coumarins) in Ducharme, Y; Blouin, M.; Brideau, C.; Chateauneuf, A.; Gareau, Y; Grimm, E. L.; Juteau, H.; Laliberte, S.; MacKay, B.; Masse, F.; Ouellet, M.; Salem, M.; Styhler, A.; Friesen, R. W. The Discovery of Setileuton, a Potent and Selective 5-Lipoxygenase Inhibitor. ACS Med. Chem. Lett. 2010, 1, 170-174 (denoted as compound F in this study), were selected as LeadOp examples.

Generation of Fragments.

The library of potential substitution fragments was generated by decomposing 4855 molecules from the “small molecule structures” property descriptions of the “drug structure” section in the DrugBank database (Wishart, D. S.; Knox, C.; Guo, A. C.; Cheng, D.; Shrivastava, S.; Tzur, D.; Gautam, B.; Hassanali, M. DrugBank: A Knowledgebase for Drugs, Drug Actions and Drug Targets. Nucleic Acids Res. 2008, 36, D901-D906). The DrugBank database contains chemical, pharmacological, and pharmaceutical drug data along with sequence, structure, and pathway information for various drug targets. The DrugBank compounds were energy-minimized and subsequently decomposed with DAIM to generate the fragments (Kolb, P.; Caflisch, A. Automatic and Efficient Decomposition of Two-Dimensional Structures of Small Molecules for Fragment-Based High-Throughput Docking. J. Med. Chem. 2006, 49, 7384-7392); duplicate fragments were removed, resulting in 1688 fragments being added to the LeadOp fragment library from DrugBank. LeadOp fragment library also included 1311 amine building blocks from SciFinder (heterocycles such as quinolines, imidazoles, biaryls, pyrrolizines, thiopyrano[2,3,4-c,d]indoles, naphthalenic lignan lactones, phenoxymethylpyrazoles, methoxytetrahydropyrans) and substituted coumarins from a previous studies. Fragments were removed if (i) the number of oxygen, nitrogen, sulfur, phosphates, and halogens in a fragment was greater than two, (ii) there was more than one double and/or triple bond, and (iii) there was more than two hydrogen-bonding donors or acceptors.

Predocked Fragment Database Construction.

Each fragment of the LeadOp fragment library, generated in the previous step, was docked into the B-Raf and 5-LOX binding site via SEED (Majeux, N.; Scarsi, M.; Apostolakis, J.; Ehrhardt, C.; Caflisch, A. Exhaustive Docking of Molecular Fragments with Electrostatic Solvation. Proteins: Struct. Funct. Genet. 1999, 37, 88-105), which explicitly calculated the desolvation energy of the fragment while exploring the fragment's possible binding modes.

Each docked fragment resulted in multiple poses and associated binding energies. A representative fragment pose was selected using a cutoff energy of 5 kcal/mol; this yielded 236 585 conformations for 1688 docked fragments. All fragments were ranked according to group efficiency, calculated by dividing the fragment's docked binding energy with the number of heavy atoms within the fragment. The resulting prioritized, predocked fragments database contained 27417 conformers for 1688 fragments.

Preparation for Optimization.

Compounds to be docked were geometry optimized with the MM+force field in HyperChem 7.0 (HyperChem, Version 7.0; Hypercube, Inc.: Gainesville, Fla., 2007) and docked into the target protein binding sites with AutoDock Vina (Trott, 0.; Olson, A. J. Software News and Update AutoDock Vina: Improving the Speed and Accuracy of Docking with a New Scoring Function, Efficient Optimization, and Multithreading. J. Comput. Chem. 2010, 31, 455-461) using the default settings.

Selection of Fragments to be Replaced.

The ability to indicate how the docked inhibitors are decomposed along with which fragments are retained are user specifications within the LeadOp protocol. The decomposition retains the docked orientation and position of each fragment, and the group efficiency of each fragment is calculated. The top 20% of the original fragments (from the original query molecule), on the basis of group efficiency, are automatically retained while the remainder of the original fragments undergo replacement.

Tabu Search for Better Replacement and Compounds Assembly.

To efficiently search and determine reasonable replacement fragments, a look-up table consisting of the bond distances and angles between the fragments and the original compound's attachment points (location of substituents to be exchanged) is constructed. Acceptable bond distance(s) and angle(s) between the fragment and the potential attachment point are a key indicator to determine if the docked fragment should be a possible replacement. The new compounds are generated by connecting all the possible combinations of fragments to the remaining initial ligand based on appropriate bond lengths and angles.

Trimming the Potential Compound Library.

After the assembling the compounds and removing those that violate Lipinski's rules-of-five, the following filters are applied to reduce the total number of new compounds. Compounds with (i) four or more double bonds (excluding aromatic bonds) or triple bonds with no more than three of each type or (ii) 11 or more triple bond are removed from the potential set of compounds. After reducing the compounds that violate the above rules, each compound is energy minimized and prioritized (ranked) using the overall binding energy.

Molecular Dynamics Simulations.

The bound pose of the newly constructed compound, as determined with AutoDock Vina (Trott, O.; Olson, A. J. Software News and Update AutoDock Vina: Improving the Speed and Accuracy of Docking with a New Scoring Function, Efficient Optimization, and Multithreading. J. Comput. Chem. 2010, 31, 455-461), is refined from the lowest binding free energy and the number of favorable ligand-receptor interactions within the binding site. The unfavorable contacts between the docked pose of the energy-minimized “constructed” compound (fragments connected to the remaining initial compound) and the residues within the binding site are removed using molecular dynamics simulations, thus allowing the complex to explore local energy minima. The best complex pose was selected and molecular dynamics was performed using GROMACS version 4.03 (Hess, B.; Kutzner, C.; van der Spoel, D.; Lindahl, E. GROMACS 4: Algorithms for Highly Efficient, Load-Balanced, and Scalable Molecular Simulation. J. Chem. Theory Comput. 2008, 4, 435-447) and the GROMOS 53A6 force field (Oostenbrink, C.; Soares, T. A.; van der Vegt, N. F. A.; van Gunsteren, W. F. Validation of the 53A6 GROMOS Force Field. Eur. Biophys. J. 2005, 34, 273-284). The complexes are placed in a simple cubic periodic box of SPC216-type water molecules (Berendsen, H. P., JPM; van Gunsteren, W. F.; Hermans, J. Interaction Models for Water in Relation to Protein Hydration. In Intermolecular Forces; Pullman, B., Ed.; Reidel: Dordrecht, The Nether lands. 1981; pp 331-342), and the distance between protein and each edge of the box was set as 0.9 nm To maintain overall electrostatic neutrality and isotonic conditions, Na⁺ and Cl⁻ ions were randomly positioned within this solvation box. To maintain the proper structure and remove unfavorable van der Waals contacts, a 1000-step energy minimization using the steepest descent algorithm was employed with an energy minimization convergence criteria of a between-step difference smaller than 1000 kJ mol⁻¹ nm⁻¹. After the energy minimization, the system was subjected to a 1200 ps molecular dynamics simulation at constant temperature (300 K), pressure (1 atm), and a time step of 0.002 ps (2 fs) with the coordinates of the systems recorded every 1 ps.

### Example 1

### LeadOp for Structure-Based Fragment Hopping of B-Raf Inhibitors

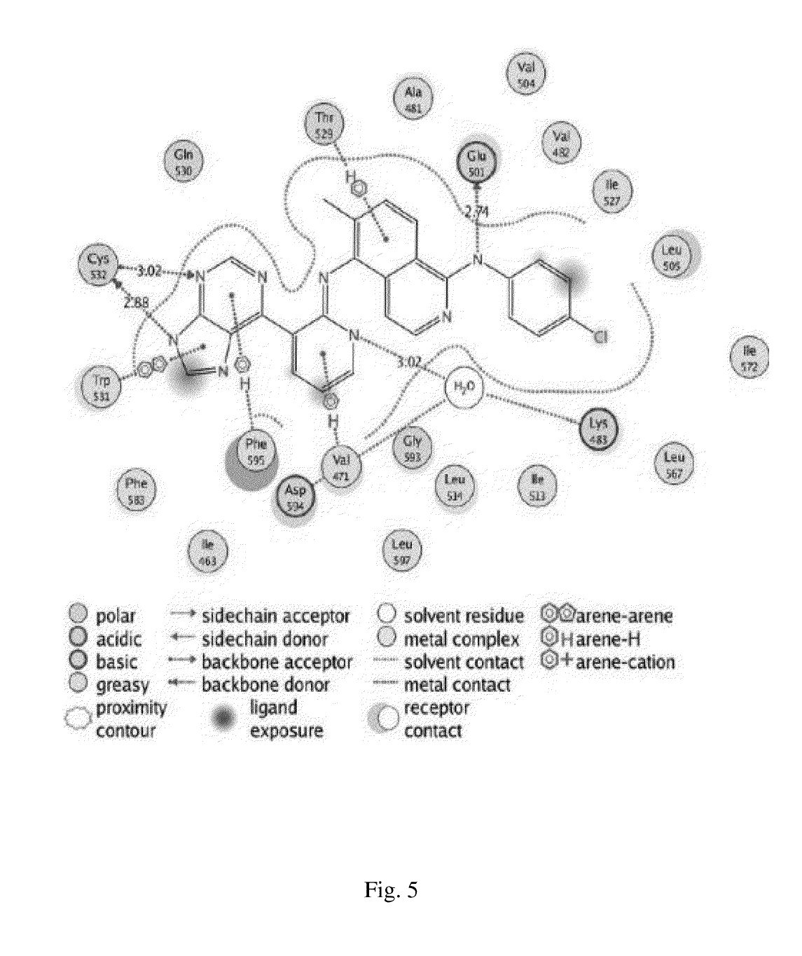

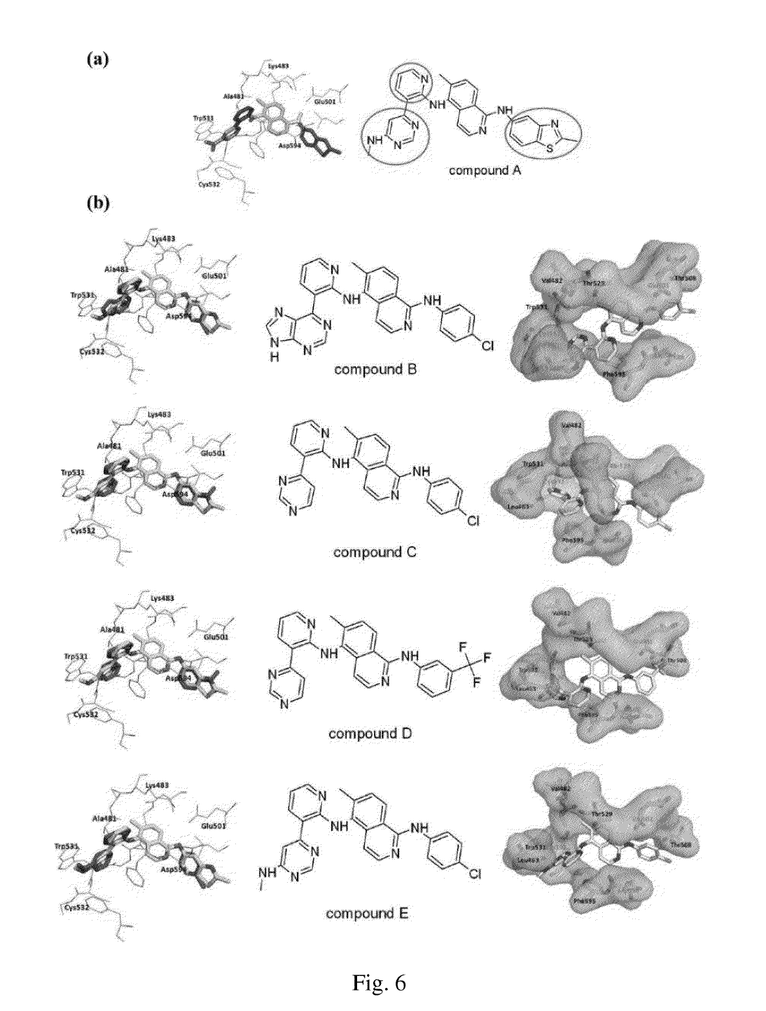

For the B-Raf inhibitors example, a mutant B-Raf and a ras activated proto-oncogene serine/theronione protein kinase were selected. An aminoisoquinolines series of mutant B-Raf pathway inhibitors was investigated in the prior art (Smith, A. L.; DeMorin, F. F.; Paras, N. A.; Huang, Q.; Petkus, J. K.; Doherty, E. M.; Nixey, T.; Kim, J. L.; Whittington, D. A.; Epstein, L. F.; Lee, M. R.; Rose, M. J.; Babu, C.; Fernando, M.; Hess, K.; Le, Q.; Beltran, P.; Carnahan, J. Selective Inhibitors of the Mutant B-Raf Pathway: Discovery of a Potent and Orally Bioavailable Aminoisoquinoline. J. Med. Chem. 2009, 52, 6189-6192), and a cocrystal structure of inhibitor LW with B-Raf shows the interactions in the B-Raf active site (PDB ID: 3idp). In this cocrystal structure, the purine group of LW forms several stabilizing interactions with the receptor: (i) two hydrogen bonds with Cys532 of B-Raf (one with the backbone amine and the other with the backbone carboxyl group), (ii) n′-stacking with the side chain of Trp531, and (iii) a a-hydrogen atom interaction with Phe595. FIG. 5 illustrates the ligand-receptor interaction of this cocrystal structure. A pose similar to the solved crystal structure of LW bound to B-Raf was determined through our docking study. Therefore, the same AutoDock Vina parameters were used to dock compound A, from the same series, into the binding pocket; FIG. 6a illustrates the docked pose. Compound A was selected for optimization by the LeadOp algorithm in this example. The aminoisoquinoline core was preserved during the fragment hopping due to its kinase selectivity and favorable pharmacokinetic properties. Compound A-docked to B—Raf—was decomposed (fragmented) into six fragments (Frag-O to Frag-5 in Table 1, indicated using different colors in FIG. 6a), and the group efficiency scores were calculated.

TABLE 1
Evaluation of the Six Fragments, Frag-0 to Frag-5, from Compound A for the B-Raf
Biological System with Binding Free Energy (AG) and Group Efficiency (GrpEff)^{b}

| | | ΔG | ΔGrpEff | |
|---|---|---|---|---|
| | Structure | (kcal · mol⁻¹) | (kcal · mol⁻¹HA^{-1a}) | T/F |
| Compound A | 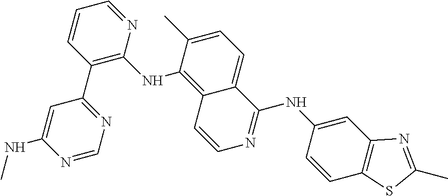 | −10.23 | −0.28 | |
| Frag-0 | 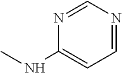 | −3.60 | −0.43 | T |
| Frag-1 | 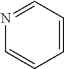 | −2.57 | −0.42 | T |
| Frag-2 | 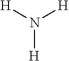 | −0.42 | −0.42 | F |
| Frag-3 | 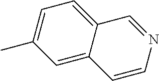 | −6.10 | −0.55 | F |
| Frag-4 | 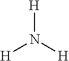 | −3.12 | −0.56 | F |
| Frag-5 | 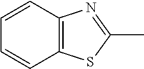 | −4.59 | −0.45 | T |

^{a}HA is the number of non-hydrogen atoms in the fragment.
^{b}The fragments selected to be replaced are marked as T and those preserved are marked as F.

More positive group efficiency values infer a weaker binding interaction than fragments with lower values. Thus, the original ligand fragments with the most positive group efficiency scores were selected for replacement (Frag-O, Frag-1, and Frag-5 in Table 1) under the user-defined selection mode. The new compounds were constructed after replacement of the weakly performing (binding) fragments with fragments considered to have “better” interactions with the receptor. The last step of LeadOp is the ranking of the new compounds based on their calculated binding energy. For this example, 5576 new B-Raf inhibitors were generated, evaluated, and ranked. To evaluate our algorithm, we compared all of the LeadOp generated compounds to the proposed aminoisoquinoline analogs from the original literature and found that six of the LeadOp compounds (FIG. 6b) are among the 12 proposed aminoisoquinoline analogs that have been synthesized and measured in the prior art (Smith, A. L.; DeMorin, F. F.; Paras, N. A.; Huang, Q.; Petkus, J. K.; Doherty, E. M.; Nixey, T.; Kim, J. L.; Whittington, D. A.; Epstein, L. F.; Lee, M. R.; Rose, M. J.; Babij, C.; Fernando, M.; Hess, K.; Le, Q.; Beltran, P.; Carnahan, J. Selective Inhibitors of the Mutant B-Raf Pathway: Discovery of a Potent and Orally Bioavailable Aminoisoquinoline. J. Med. Chem. 2009, 52, 6189-6192). The inclusive replacement of fragments (substituents) combined with systematically examining the proposed fragment's interactions with the receptor while retaining the core generated six compounds that have more potent IC₅₀ values than the original compound (compound A). Four (compounds B-E) of the six generated compounds were selected for further investigation of their ligand-receptor interactions to represent diverse IC₅₀ values. The poses, ligand-receptor interactions, and the replaced fragments (in red) of these four compounds are shown in FIG. 6b. It is interesting to note that even though Frag-0, Frag-1, and Frag-5 were possible replacement locations, these three fragments are retained in their original location for several of the final structures. Compound B (the most active compound among the four proposed with an IC₅₀=1.6 nM) preserved Frag-1 in one of the final proposed compounds, while Frag-0 and Frag-5 were replaced with a purine and a phenylchloro group, respectively. It is interesting that compound B, generated with the LeadOp algorithm, is the same structure as the original ligand (inhibitor L1E) of the cocrystal structure (PDB ID: 3idp). Compound C kept Frag-1 in its final state while Frag-0 and Frag-5 were replaced with pyrimidine and phenylchloro groups, respectively. Compound D retained Frag-1 in the final compound, and Frag-0 and Frag-5 were replaced with pyrimidine and trifluoromethylphenyl groups, respectively. Compound E combined Frag-0 and Frag-1, resulting in Frag-0, yet Frag-5 was replaced with the phenylchloro group. The detailed rankings from our algorithm for the compounds B-E, X, and Y on the basis of biologically measured IC₅₀, depicted structure, and the predicted binding energy are reported in Table 2.

TABLE 2
Ranking of the New Compounds Generated by the LeadOp Algorithm and Their
Biologically Determined Inhibition Potency (IC50) of B-Raf from HyperChem, Version 7.0;
Hypercube, Inc.: Gainesville, FL, 2007.

| Rank | Compound | IC₅₀ (nM) | Predicted binding energy (kcal · mol⁻¹) | Original rank |
|---|---|---|---|---|
| Query | 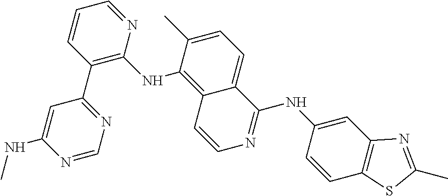 compound A | 110 | −10.23 | |
| 1 | 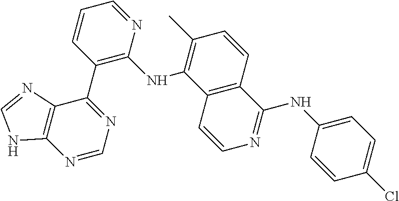 [SMILES: Cc1ccc2c(Nc3ccc(Cl)cc3)nccc2c1Nc1ncccc1-c1ncnc2[nH]cnc12] compound B | 1.6 | −12.64 | 21 |
| 2 | 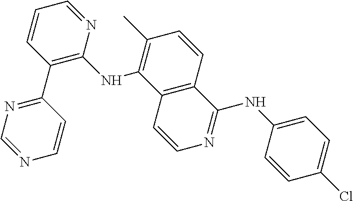 [SMILES: Cc1ccc2c(Nc3ccc(Cl)cc3)nccc2c1Nc1ncccc1-c1ccncn1] compound C | 3.4 | −12.53 | 65 |
| 3 | 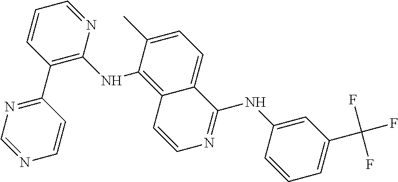 [SMILES: Cc1ccc2c(Nc3cccc(C(F)(F)F)c3)nccc2c1Nc1ncccc1-c1ccncn1] compound D | 17 | −11.86 | 584 |
| 4 | 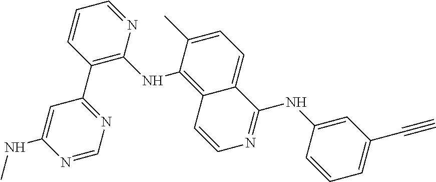 [SMILES: C#Cc1cccc(Nc2nccc3c(Nc4ncccc4-c4cc(NC)ncn4)c(C)ccc23)c1] compound X | 18 | −11.37 | 1035 |
| 5 | 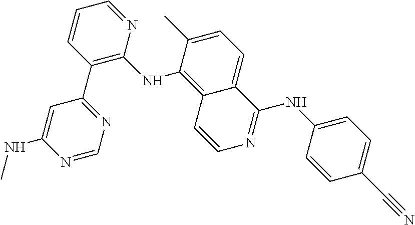 [SMILES: CNc1cc(-c2cccnc2Nc2c(C)ccc3c(Nc4ccc(C#N)cc4)nccc23)ncn1] compound Y | 39 | −11.11 | 1371 |
| 6 | 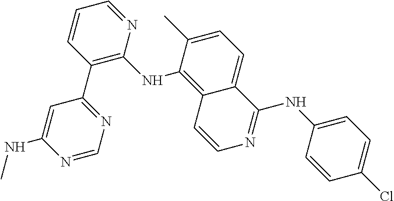 [SMILES: CNc1cc(-c2cccnc2Nc2c(C)ccc3c(Nc4ccc(Cl)cc4)nccc23)ncn1] compound E | 56 | −10.83 | 2056 |

^{a}All new compounds have a higher potency than the query compound, and the suggested priority of the new compounds with the predicted binding energy as well as their original rankings (out of 5576) from the algorithm have a similar trend as the IC₅₀ potency values from HyperChem, Version 7.0; Hypercube, Inc.: Gainesville, FL, 2007.

Molecular dynamics simulation studies were performed to further investigate the resulting ligand-receptor interactions as suggested by our algorithm (LeadOp) and to explore the possible interactions within the cocrystal complex of B-Raf and compound LW (Smith, A. L.; DeMorin, F. F.; Paras, N. A.; Huang, Q.; Petkus, J. K; Doherty, E. M.; Nixey, T.; Kim, J. L.; Whittington, D. A.; Epstein, L. F.; Lee, M. R.; Rose, M. J.; Babij, C.; Fernando, M.; Hess, K.; Le, Q.; Beltran, P.; Carnahan, J. Selective Inhibitors of the Mutant B-Raf Pathway: Discovery of a Potent and Orally Bioavailable Aminoisoquinoline. J. Med. Chem. 2009, 52, 6189-6192). The generated compounds B-E were energically optimized and docked into the receptor's binding site as described previously in the Materials and Methods. Molecular dynamics simulation studies were performed with the final poses of the compounds B-E with respect to B-Raf, and the unique low-energy conformations of the complexes, from the last 50 ps of the MDS (50 configurations), are shown in FIG. 6b. The available cocrystal of the B-Raf-L1E complex shows hydrogen-bonding interactions between Cys532 of B-Raf and the purine group, hydrogen bond interactions between Glu501 and a nitrogen atom connecting two aromatic groups, a hydrogen bond between an aromatic nitrogen of LIE and a bound water that is hydrogen bonded to Asp594 and Lys483 of B-Raf, and a potential favorable a-stacking interaction with the side chain of Trp531 (Smith, A. L.; DeMorin, F. F.; Paras, N. A.; Huang, Q.; Petkus, J. K.; Doherty, E. M.; Nixey, T.; Kim, J. L.; Whittington, D. A.; Epstein, L. F.; Lee, M. R.; Rose, M. J.; Bablj, C.; Fernando, M.; Hess, K.; Le, Q.; Beltran, P.; Carnahan, J. Selective Inhibitors of the Mutant B-Raf Pathway Discovery of a Potent and Orally Bioavailable Aminoisoquinoline. J. Med. Chem. 2009, 52, 6189-6192). We observe similar hydrogen-bonding interactions between the aminoisoquinoline group in compound B with binding site residues Asp594 and Glu507 and between the purine group of compound B and residues Leu463 and Cys532 of the receptor. Compound C has a similar set of hydrogen bond interactions—as compared to B-Raf-L1E complex—between itself and Asp594 and Cys532 along with two additional hydrogen-bond interactions with residues Lys483 and Thr529. Compounds D and E also display key hydrogen-bond interactions that are similar to those between L1E's three nitrogen groups and the surrounding binding site residues (the nitrogen atom bridging two aromatic ring groups and Glu501, a nitrogen atom in an aromatic ring and Asp594 via a bound water molecule, and two nitrogen atoms of an aromatic ring group and the backbone hydrogen-bond acceptor and donor of Cys532).

### Example 2

### LeadOp for Structure-Based Fragment Hopping of Human 5-Lipoxygenase Inhibitors

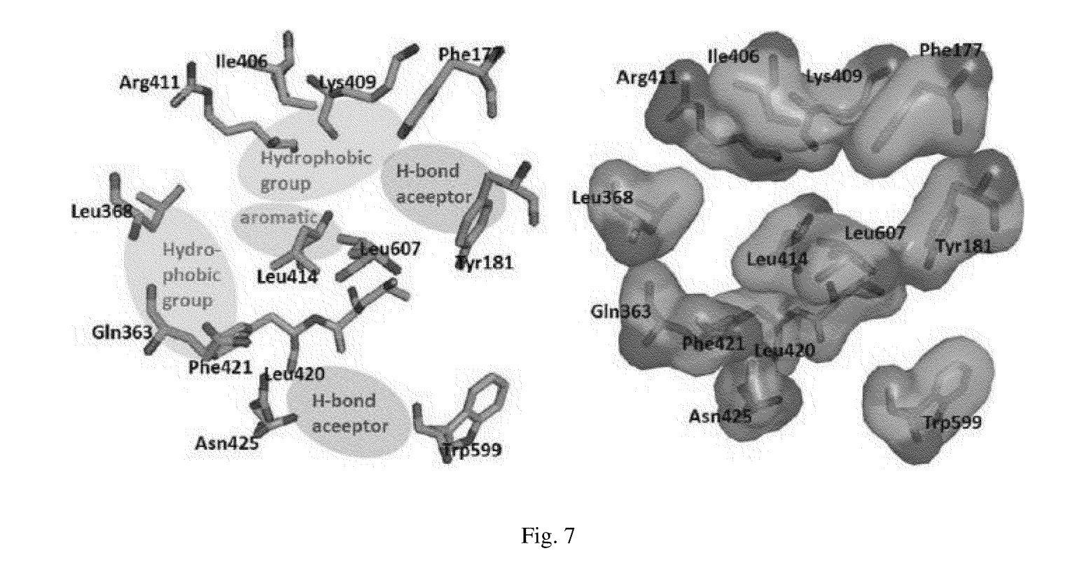

The human 5-lipoxygenase (5-LOX) enzyme with the well-known 5-LOX inhibitors was selected as the second LeadOp test case. To design better 5-LOX inhibitors, structural insight of the 5-LOX active site and its associated interactions with ligands would be helpful; unfortunately, the crystal structure of this enzyme has yet to be elucidated. We selected a theoretical model (comparative/homology protein structure/model) of 5-LOX (Charlier, C.; Henichart, J.-P.; Durant, F.; Wouters, J. Structural Insights into Human 5-Lipoxygenase Inhibition: Combined Ligand-Based and Target-Based Approach. J. Med. Chem. 2006, 49, 186-195) that has good agreement with mutagenesis studies. The proposed active site of 5-LOX forms a deep and bent cleft that extends from Phe177 and Tyr181 on the top of the cleft to the Trp599 and Leu420 at the bottom (shown in FIG. 7). Most of the residues lining the cleft are hydrophobic with several polar residues (Gln363, Asn425, Gln557, Ser608, and Arg411) distributed along the channel that have the ability to interact with ligands during the binding process. A small side pocket off of the main channel is composed of hydrophobic residues (Phe421, Gln363, and Lue368), and it is postulated that lipophilic interactions with the ligand may enhance activity.

The purported major pharmacophore interactions needed for ligand binding to 5-LOX include (i) two hydrophobic groups, (ii) a hydrogen-bond acceptor, (iii) an aromatic ring, and (iv) two secondary interactions. These two secondary interactions are between the ligand and an acidic moiety and a hydrogen-bond acceptor within the binding pocket of the receptor. The hydrogen-bond acceptor probably interacts with the key anchoring points (Tyr181, Asn425, and Arg411) to form the hydrogen bond, while Leu414 and Phe421 form a hydrophobic interaction between the ligand and the binding cavity.

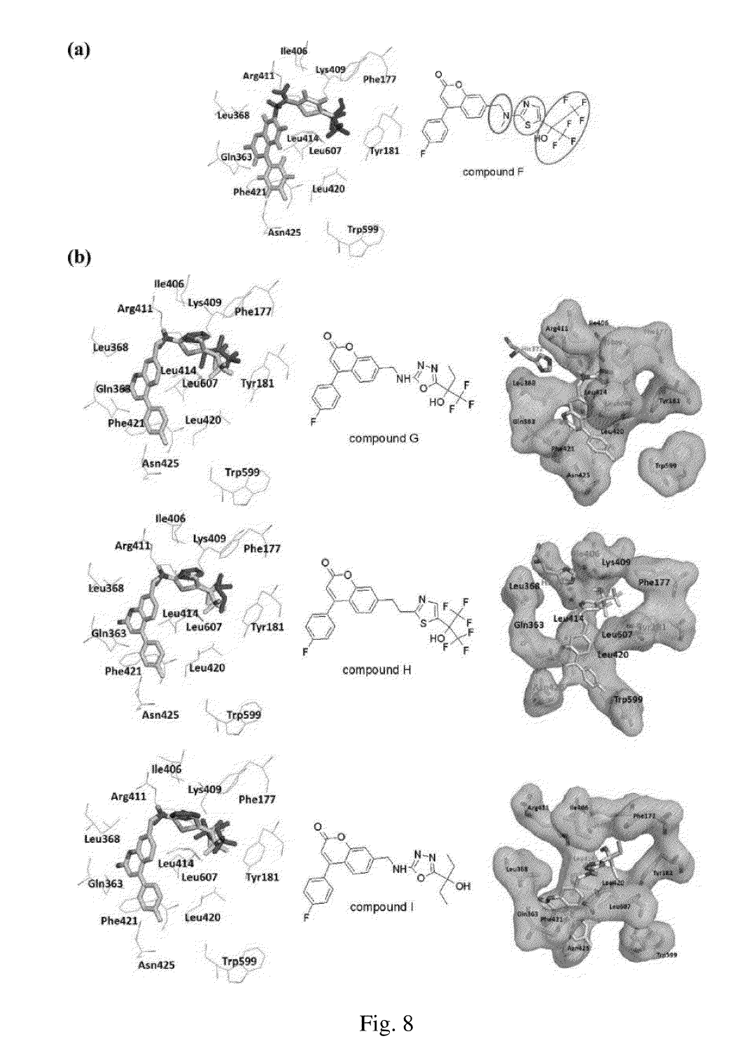

The 5-LOX inhibitor compound F (compound 6 in Ducharme, Y.; Blouin, M.; Brideau, C.; Chateauneuf, A.; Gareau, Y.; Grimm, E. L.; Juteau, H.; Laliberte, S.; MacKay, B.; Masse, F.; Ouellet, M.; Salem, M.; Styhler, A.; Friesen, R. W. The Discovery of Setileuton, a Potent and Selective 5-Lipoxygenase Inhibitor. ACS Med. Chem. Lett. 2010, 1, 170-174) was selected as our initial molecule for lead optimization and has a biologically determined IC50 value of 145 nM. Compound F was docked into the theoretical 5-LOX binding site and the lowest energy conformation was submitted to LeadOp. This selected conformation possesses similar interactions that have been previously reported and discussed above within at the 5-LOX active site (FIG. 7). The oxochromen group favorably interacts with the hydrophobic residue Leu414 (CH . . . π interaction) in the middle of the cavity, while the fluorophenyl group extends to the hydrogen-bond-acceptor region in the lower cleft of the active site. The docked conformation was selected as the query molecule and was decomposed into the five fragments shown in FIG. 8a.

The group efficiency was evaluated for each of the decomposed fragments to determine if it is eligible for replacement. The oxochromen and fluorophenyl groups (Frag-O and Frag-1 in Table 3, respectively) were considered the largest contributing features for ligand binding to 5-LOX according to Charlier, C.; Henichart, J.-P.; Durant, F.; Wouters, J. Structural Insights into Human 5-Lipoxygenase Inhibition: Combined Ligand-Based and Target-Based Approach. J. Med. Chem. 2006, 49, 186-195 and our observations from the docking simulation, decomposition, and group efficiency calculation. On the basis of these circumstances, the oxochromen and fluorophenyl groups were therefore preserved during the replacement portion of LeadOp. As in the B-Raf example, LeadOp can identify analogs (compounds G-I in FIG. 8b) that were previously proposed, synthesized, and had their biological end points measured while also discovering compound F in the literature.

TABLE 3
Evaluation of the Five Fragments, Frag-0 to Frag-4, from Compound F, a Human 5-
LOX Inhibitor with Binding Free Energy (AG) and Group Efficiency (GrpEff)^{b}

| | | ΔG | ΔGE | |
|---|---|---|---|---|
| | Structure | (kcal · mol⁻¹) | (kcal · mol⁻¹HA^{-1a}) | T/F |
| Compound F | 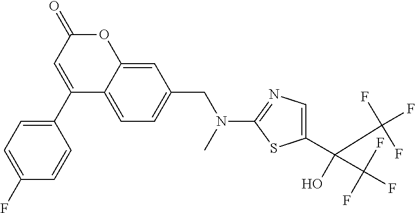 [SMILES: CN(Cc1ccc2c(-c3ccc(F)cc3)cc(=O)oc2c1)c1ncc(C(O)(C(F)(F)F)C(F)(F)F)s1] | −7.00 | −0.19 | |
| Frag-0 | 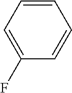 | −3.04 | −0.44 | F |
| Frag-1 | 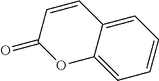 [SMILES: O=c1ccc2ccccc2o1] | −5.32 | −0.48 | F |
| Frag-2 | 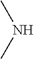 | −0.87 | −0.29 | T |
| Frag-3 | 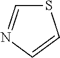 | −1.23 | −0.25 | T |
| Frag-4 | 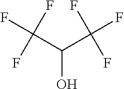 | −3.41 | −0.34 | T |

^{a}HA is the number of non-hydrogen atoms in the fragment.
^{b}The fragments selected to be replaced are marked as T and those preserved are marked as F.

In the final set of proposed compounds, compound G (the strongest inhibitor among those that were previously proposed; IC₅₀=10 nM) and compound I (IC₅₀=130 nM) were the most potent; compound G was generated by replacing Frag-2, Frag-3, and Frag-4 of compound F with a secondary amine, an oxadiazole ring, and a —C(CH₂CH₃)(CF₃)OH, respectively, and compound I was created by replacing Frag-4 of compound F with —C(CH₂CH₃)₂OH. Compound H (IC₅₀=64 nM) preserved Frag-3 and Frag-4 of compound F, while Frag-2 was replaced with an alkyl group. The three compounds suggested by LeadOp, based on the query molecule compound F, were ranked with respect to their predicted binding energy. Depicted representations of compounds F—I, as well as the corresponding inhibition data from the biological experiments and their predicted binding energy, are listed in Table 4.

TABLE 4
Ranking of the New Compounds Generated by the LeadOp Algorithm and the
Inhibition Potency (IC₅₀) of Human 5-LOX from the Literature (Trott, O.; Olson, A. J. Software
News and Update AutoDock Vina: Improving the Speed and Accuracy of Docking with a New
Scoring Function, Efficient Optimization, and Multithreading. J. Comput. Chem. 2010, 31,
455-461).

| Rank | Compound | IC₅₀ (nM) | Predicted binding energy (kcal · mol⁻¹) | Original rank |
|---|---|---|---|---|
| Query | 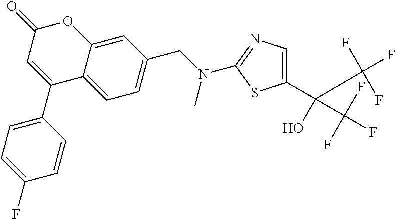 [SMILES: CN(Cc1ccc2c(-c3ccc(F)cc3)cc(=O)oc2c1)c1ncc(C(O)(C(F)(F)F)C(F)(F)F)s1] compound F | 145 ± (15) | −7.00 | |
| 1 | 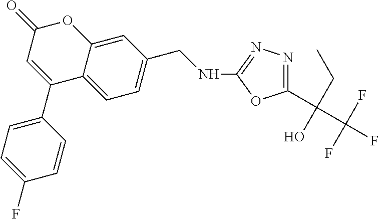 [SMILES: CCC(O)(c1nnc(NCc2ccc3c(-c4ccc(F)cc4)cc(=O)oc3c2)o1)C(F)(F)F] compound G | 10 ± (3) | −10.56 | 81 |
| 2 | 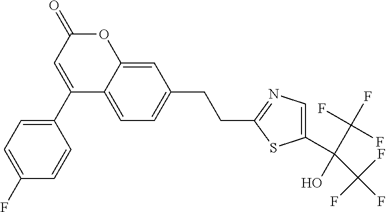 [SMILES: O=c1cc(-c2ccc(F)cc2)c2ccc(CCc3ncc(C(O)(C(F)(F)F)C(F)(F)F)s3)cc2o1] compound H | 64 ± (3) | −9.92 | 204 |
| 3 | 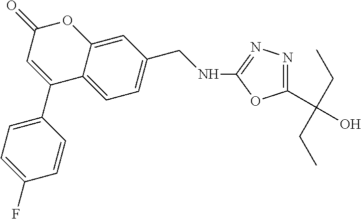 [SMILES: CCC(O)(CC)c1nnc(NCc2ccc3c(-c4ccc(F)cc4)cc(=O)oc3c2)o1] compound I | 130 ± (25) | −7.05 | 1339 |

^{a}All new compounds have a higher potency than the query compound, and the suggested priority of the new compounds with the predicted binding energy as well as their original rankings (out of 1637) from the algorithm have a similar trend as the IC50 potency values from the literature.

The three LeadOp proposed compounds were submitted to molecular dynamics simulations (MDSs) to analyze the ligand-receptor interactions within the 5-LOX active site. FIG. 8b displays the last conformation from the MDS along with the interaction between each ligand and the 5-LOX binding site. The interactions of compounds G-I all contain the hydrogen-bonding interactions between the oxygen or nitrogen atoms of the thiazol group at the Frag-2 or Frag-3 position. In compounds G and H, the fluoro group at the Frag-4 position extends to the hydrogen-bond acceptor in the upper domain of the active site and interacts with Lys409 through hydrogen bonding. In addition, the oxochromen ring of Frag-1 is in close proximity to Leu414 and is potentially an important CH . . . π (contact, as indicated in Charlier, C.; Henichart, J.-P.; Durant, F.; Wouters, J. Structural Insights into Human 5-Lipoxygenase Inhibition: Combined Ligand-Based and Target-Based Approach. J. Med. Chem. 2006, 49, 186-195. Also, Frag-3 of compound G interacts with 5-LOX hydrophobic residues Leu420 and Leu607, which have been suggested to improve binding in the 5-LOX system via complementary hydrophobic interaction between the ligand and receptor, which probably explains compound G's better inhibition compared to compounds F, H, and I. These optimized results indicate that hydrogen-bonding and hydrophobic interactions are important for ligands binding to and inhibition of 5-LOX, as previously reported.

The diversity of the fragment database is a critical factor when searching for substituent fragments. The number of different poses determined by docking fragments to each binding location is always important. The more substructural classes and docked conformations in the fragment database, for the system of interest, results in a greater number of possible combinations that are available to generate new compounds. As LeadOp is an optimization algorithm that starts with a query molecule, better lead optimization occurs when starting with a strong inhibitor.

### II. Lead Optimization Using LeadOp+R

### Materials and Methods for LeadOp+R

Overall Procedure.

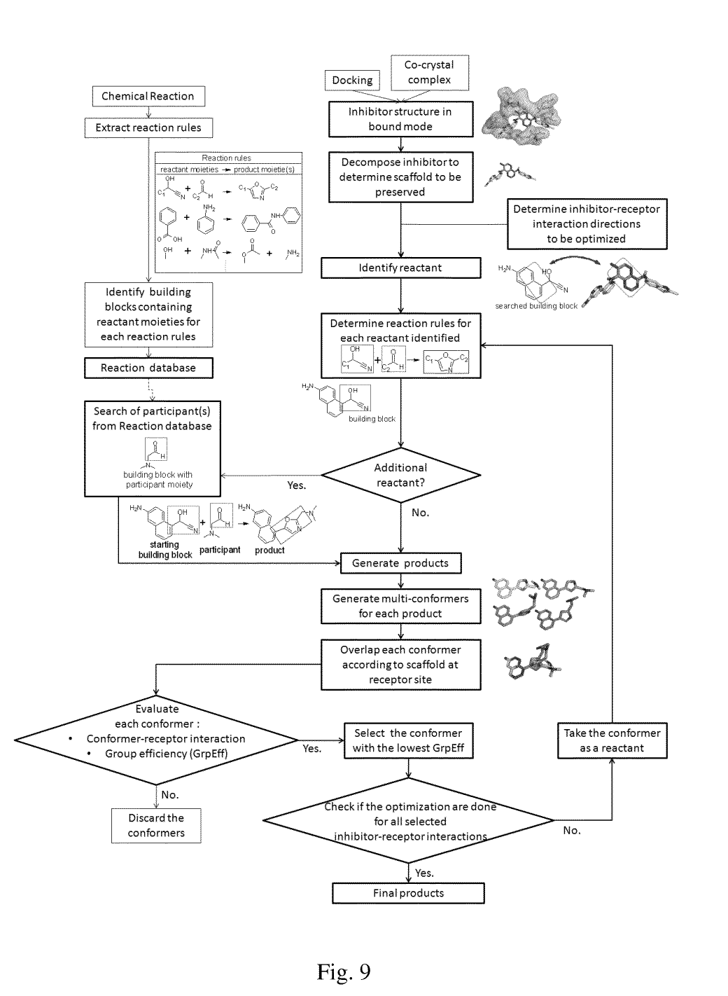

The general protocol for LeadOp+R is illustrated in FIG. 9 and details of each step are described in the following sections. Prior to applying the LeadOp+R optimization procedure, a reaction rule database is constructed, containing reaction rules for the reactant moiety, the product moiety, and the building blocks of each reaction. Thus, participants involved in each reaction are known for synthetic assessment in LeadOp+R. The initial step of LeadOp+R requires the user to select the favored inhibitor-receptor interaction positions for optimization. The inhibitor-receptor interaction positions determine the “direction” for virtual synthesis and optimizations. LeadOp+R will systematically optimize and grow a structure until all the user-defined directions are processed. LeadOp+R initiates the analysis with the complex structure of inhibitor-receptor from docking studies or crystal structures. The user can determine which fragment(s) in the query inhibitor (initial compound) to preserve during optimization. To ensure that the initial synthesis is accessible, the starting building block containing the preserved fragment is used as the initial building block. LeadOp+R then search the reaction rule database with this building block to identify associated reactions rules. Once the reactions rules and associated participants are identified, the products of each reaction rules are generated virtually. To select the best binding conformation of the proposed compound, multiple conformers are constructed of each compound. The conformer of each compound with the lowest group efficiency value is selected as the initial conformer of the next building block until the program reaches the termination condition. By evaluating the contribution of each product upon binding with group efficiency, LeadOp+R selects compounds that bind stronger yet possess less heavy atoms. The compounds that pass a set of molecular property filters comprised the final list of proposed compounds. Following a short molecular dynamics simulations, the compounds are energy-minimized and ranked on the basis of the overall ligand-receptor binding (interaction) energy. This provides a series of new and more potent compounds that are chemical accessibility.

Example Systems.

Tie-2 kinase (PDB: 2p4i), an endothelium-specific receptor tyrosine kinase (Hodous, B. L.; Geuns-Meyer, S. D.; Hughes, P. E.; Albrecht, B. K.; Bellon, S.; Bready, J.; Caenepeel, S.; Cee, V. J.; Chaffee, S. C.; Coxon, A.; Emery, M.; Fretland, J.; Gallant, P.; Gu, Y.; Hoffman, D.; Johnson, R. E.; Kendall, R.; Kim, J. L.; Long, A. M.; Morrison, M.; Olivieri, P. R.; Patel, V. F.; Polyerino, A.; Rose, P.; Tempest, P.; Wang, L.; Whittington, D. A.; Zhao, H. J. Med. Chem. 2007, 50, 611.) and human 5-LOX enzyme (Charlier, C.; Hénichart, J.-P.; Durant, F.; Wouters, J. J. Med. Chem. 2006, 49, 186.) a key enzyme in leukotriene biosynthesis, were selected as model systems to examine the LeadOp+R approach. One Tie-2 kinase inhibitor, compound 46 in Hodous, B. L. et al. (denoted as compound rA in this study) and a human 5-LOX inhibitor, compound 7 (substituted coumarins) in Ducharme, Y. et al (Ducharme, Y.; Blouin, M.; Brideau, C.; Chateauneuf, A.; Gareau, Y.; Grimm, E. L.; Juteau, H.; Laliberte, S.; MacKay, B.; Masse, F.; Ouellet, M.; Salem, M.; Styhler, A.; Friesen, R. W. ACS Med. Chem. Lett. 2010, 1, 170.). (denoted as compound rB in this study), were selected as the LeadOp+R optimization examples.

Construction of the LeadOp+R Reaction Database.

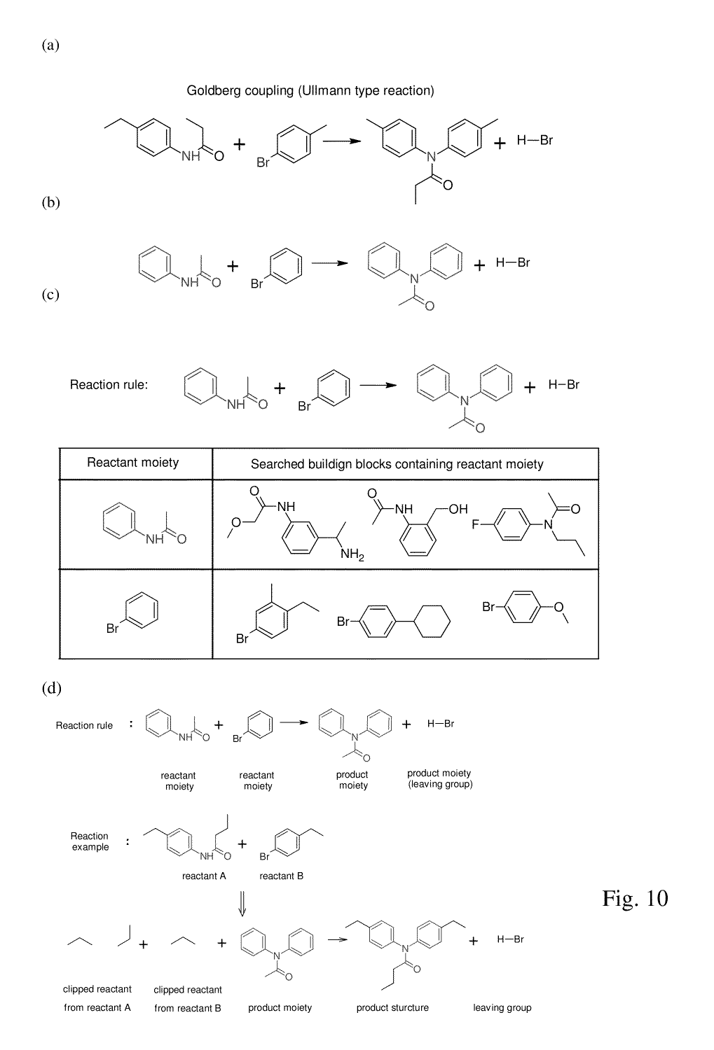

LeadOp+R collects chemical reactions, building blocks, and reaction rules with reactant moieties and product moieties of each reaction to construct the LeadOp+R reaction database. LeadOp+R includes 198 classic chemical reactions from the Reaxy Database and 2,091 organic building blocks from the commercially available Sigma-Alderich Co. product library (Sigma-Aldrich Chemie GmbH, Steinheim, GE). These building blocks include the typical building blocks in a chemical synthesis such as various nitrogen compounds (amines, isocyanides) and carbonyl compounds (amides, aldehydes, and ketones). A reaction rule in LeadOp+R includes the reactant moieties and product moieties extracted from the full structure of reactants and products of each reaction collected. In LeadOp+R, the reaction moieties were defined and extracted from a chemical reaction according the following steps (see FIG. 10 for the illustration of the steps):

### (1) Identification of Reaction Core.

A collection of atoms that take part in the chemical transformation (reaction) have their atom type changed (element, number and type of bonds, and number of neighboring atoms) are considered the reaction core. These atoms are determined by comparing the atoms of the starting compound and product to those within the LeadOp+R reaction database; atoms that differ are part of the reaction core. Since the reaction core does not contain enough chemical information to accurately describe the reaction, additional information is gathered from atoms bound to the reaction core.

Extraction of the Reactant and Product Moieties for a Reaction.

The initial reaction cores typically do not include enough atoms and thus their “chemical environment” is expanded. The reaction core is increased to bonded (neighboring) atoms until the minimum reactant and product substructures are included to fully represent the reaction. Within a reaction, the reactant portion is denoted as the “reactant moiety” and as expected the product portion is denoted as “product moiety”. The extension step is done by traversing the atom types within the reaction core, as discussed in Step 1, until a single sp carbon is found and the atoms searched during the extension step are considered as part of the same moiety. For cases where the searched atoms are in an aromatic ring, the extension was terminated when all the atoms in the aromatic ring are included in the moiety—all the atoms in the aromatic ring are considered part of the moiety.

Finally, the building blocks with the same reactant moiety for each reaction rule are collected (through application programming interface of JChem (JChem 5.4.1.1; ChemAxon Ltd: Budapest, Hungary.)) and classified by the reaction. Building blocks for each reaction rule are recorded and used for virtual synthesis in the LeadOp+R algorithm.

Identify Reactant.

LeadOp+R initiates the analysis of a complexed structure (inhibitor-receptor) taken from a docking study or crystal structure. LeadOp+R first allows the user to identify and preserve a space called the “fragment space” that is defined by the volume occupied by a fragment of the query molecule LeadOp+R then searches for building blocks with the same volume as the potential initial reactants. Products of each potential initial reactant are virtually synthesized according to the steps below. For each product molecule that passes the evaluation step, that product molecule becomes the next reactant in the next synthesis step.

Determine Reaction Rules for Each Reactant Identified.

When a reactant is identified in the previous step, there are many potential reactant moieties and reactions associated with this reactant. Each reactant is subjected to sub-structure searching (JChem 5.4.1.1; ChemAxon Ltd: Budapest, Hungary.) to identify atom arrangements (moieties) that are part of a chemical reaction rule within the LeadOp+R reaction database to determine potential chemical reactions for this specific reactant.

Generation of Reaction Products Based on Reaction Rules.

Once all the potential reaction rules of a reactant are identified, the corresponding products are generated by “reacting” the reactant moieties and participant reactants (FIG. 10d). In LeadOp+R, each reactant has two parts: one structure matches the reactant moiety and the other structure—excluding the reactant moiety—is denoted as the “clipped reactant”. The same definition is used for other building blocks (participants) involved in a reaction. Each product is generated by combining the clipped portion of the reactant and the clipped portion of the participants as well as the product moiety based on the search of the reaction rule.

Evaluation of the Products for Each Reaction.

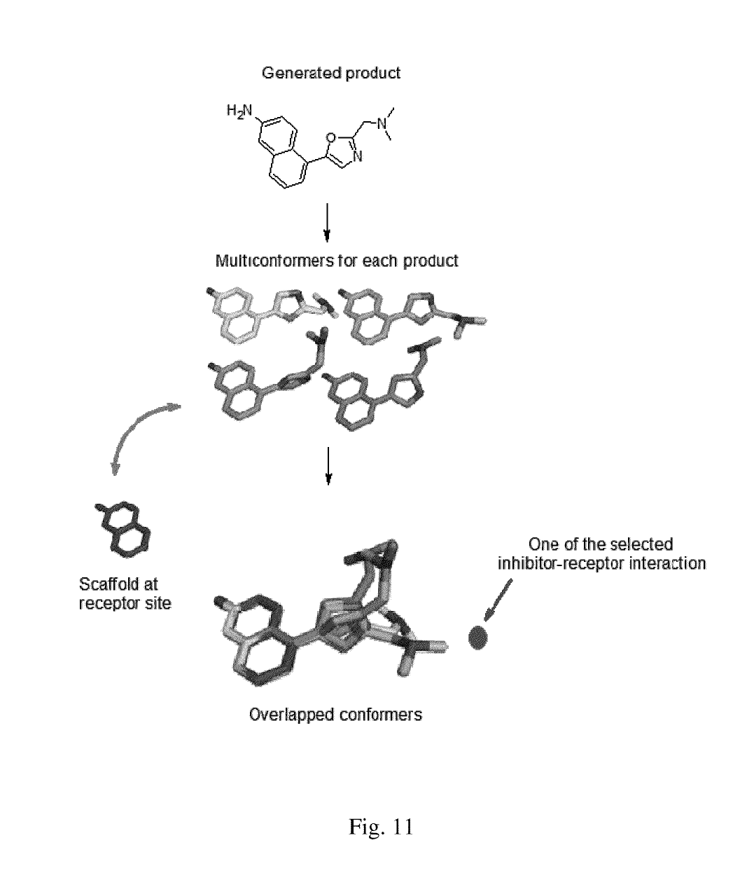

Thirty conformers of each product are generated using the Java and JChem application programming interface (Imre, G.; Kalszi, A.; Jkli, I.; Farkas, Ö. Advanced Automatic Generation of 3D Molecular Structures, presented at the 1st European Chemistry Congress, Budapest, Hungary, 2006; Marvin 5.4.0.1; ChemAxon Ltd: Budapest, Hungary). Each conformer is aligned with the preserved space of the query molecule, while maximizing the overlap volumes, using the flexible 3D alignment tool of Marvin (Marvin 5.4.0.1; ChemAxon Ltd: Budapest, Hungary) (see FIG. 11). A conformer for each product was selected for the next step if the following criteria are met: 1) the binding mode of each conformer, aligned with the query molecule within the receptor site, has the same inhibitor-receptor interaction direction, and 2) the new moiety has a group efficiency value less than −0.1.

Final Selection by Structure-Based Analysis.

The selected conformer for each product is the reactants for the next reaction in the selected inhibitor-receptor interaction direction. The molecule continues to grow until all the inhibitor-receptor interaction directions are exhausted. The collection of potential new compounds is reduced using the following criteria: molecular weight less than 600 g mol⁻¹ and a calculated lipophilicity (cLogP) less than 5, which is taken into account based on the Lipinski's Rule-of-Five (Lipinski, C. A.; Lombardo, F.; Dominy, B. W.; Feeney, P. J. Adv Drug Del Rev 2001, 46, 3.). The compounds that pass the molecular property filters comprised the final list of proposed compounds. These compounds are then energy-minimized within the binding site and ranked based on the overall ligand-receptor binding energy.

Molecular Dynamics Simulations.

The bound pose of the newly “constructed” compound, as determined with AutoDock Vina (Trott, O.; Olson, A. J. J. Comput. Chem. 2010, 31, 455.), is refined from the lowest binding free energy and the largest number of favorable ligand-receptor interactions within the binding site. The unfavorable contacts between the docked pose of the energy minimized constructed compound (fragments connected to the initial core of the compound) and the residues within the binding site are alleviated using molecular dynamics simulations; allowing the complex to explore local energy minima. The best complex pose (ligand-receptor interaction) was selected and molecular dynamics was performed using GROMACS version 4.03 (Hess, B.; Kutzner, C.; van der Spoel, D.; Lindahl, E. J. Chem. Theory Comput. 2008, 4, 435.) and the GROMOS 53A6 force field (Oostenbrink, C.; Soares, T. A.; van der Vegt, N. F. A.; van Gunsteren, W. F. Eur. Biophys. J. 2005, 34, 273). The complexes are placed in a simple cubic periodic box of SPC216 type water molecules (Berendsen, H. J. C.; Postma, J. P. M.; van Gunsteren, W. F.; Hermans, J. Interaction models for water in relation to protein hydration. Reidel; Dordrecht: 1981. Intermolecular forces. pp. 331-342.), and the distance between the protein and each edge of the box was set to 0.9 nm. To maintain overall electrostatic neutrality and isotonic conditions, Na⁺ and Cl⁻ ions were randomly positioned within the solvation box. To maintain the proper structure and remove unfavorable van der Waals contacts, a 1000-step steepest descent energy minimization was employed and terminated when the convergence criteria of an energy difference between subsequent steps differ less than 1000 kJ mol⁻¹ nm⁻¹. Following the energy minimization, the system is subjected to a 1200 ps molecular dynamics simulation at constant temperature (300K), pressure (latm), and a time step of 0.002 ps (2fs) with the coordinates of the system-recorded every ps.

### Example 3

### LeadOp+R Optimization for Tie-2 Kinase Inhibitors

Structure-Based Lead Optimization with Synthetic Routes

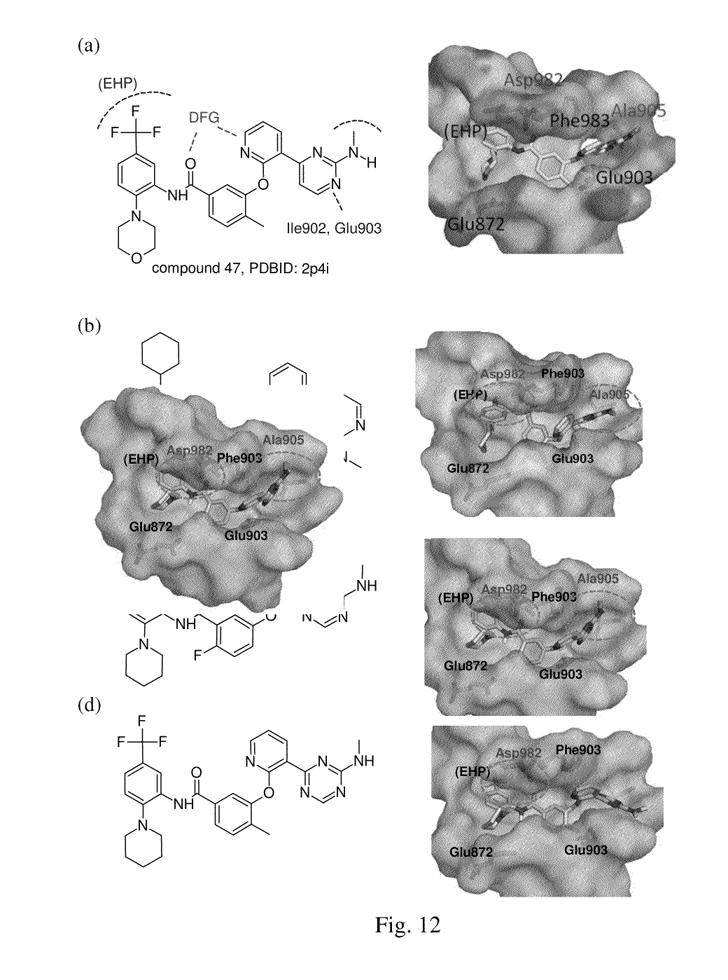

From the literature (Bridges, A. J. Chem. Rev. 2001, 101, 2541), it is known that a good kinase inhibitors should possess a hydrogen-bond donor/acceptor/donor motif to best interact with the backbone carbonyl/NH(amide)/carbonyl presented in the ATP-binding cleft. In the case of Tie-2 kinase, the residues in the active site of the ATP-binding cleft are Ala905 (carbonyl and amide NH) and Glu903 (carbonyl). Additionally, two hydrophobic pockets are part of the active site in the Tie-2 receptor and are designated as the first hydrophobic pocket (HP) and the extended hydrophobic pocket (EHP). We selected a series of Tie-2 inhibitors from the literature (Bridges, A. J. Chem. Rev. 2001, 101, 2541) containing a co-crystal structure of inhibitor compound 47 with Tie-2 receptor (PDB code: 2p4i). In this co-crystal structure, the 2-(methylamino)pyrimidine ring of inhibitor compound 47 binds to the residue Ala905 via two hydrogen bonds and the pyrimidine is also within van der Waals contact of the Glu903. The central methyl-substituted aryl ring of compound 47 resides in the first hydrophobic pocket (HP), while the pyridine ring forms an edge-to-face π-stacking interaction with Phe983 of the DFG-motif. The carbonyl oxygen makes a hydrogen bond with the backbone NH of Asp982 (DFG moti0₇ and the aryl amide moiety directs the terminal CF₃-substituted aromatic ring into the EHP. FIG. 12a illustrates the ligand-protein interaction of this co-crystal structure.

To demonstrate how LeadOp+R optimizes a compound automatically while considering the potential synthetic route, compound 46 is the query molecule for lead optimization (denoted as compound rA in this study) with a biologically determined IC₅₀ value of 399 nM (Bridges, A. J. Chem. Rev. 2001, 101, 2541). Compound rA was docked into the Tie-2 binding site and the lowest energy conformation was selected. The selected conformation possessed similar molecular interactions, as discussed earlier, with the Tie-2 active site (FIG. 12a). The amide functional group of compound rA forms a hydrogen bond with the backbone amide of Asp982, while the pyridine and benzene rings extend into the hydrophobic pocket (HP) and EHP respectively. The aminobenzoic fragment was designated as the preserved space in this example of LeadOp+R due to the important hydrogen bonding.

To evaluate our algorithm, we compared all of the LeadOp+R generated compounds to Tie-2 kinase inhibitor from the literature and found nine of the LeadOp+R compounds have also been synthesized and their ability to inhibit Tie-2 kinase measured. The inclusive synthesis of proposed products in each LeadOp+R step combined with systematically examining the proposed ligand-receptor interactions resulted in nine compounds with more potent IC₅₀ values than the original compound (compound rA). All the LeadOp+R generated compounds were energy minimized in the active site of Tie-2, and then ranked on the basis of the overall ligand-receptor interaction energy. Among all LeadOp+R suggested compounds, nine compounds were previously studied in the literature (Bridges, A. J. Chem. Rev. 2001, 101, 2541), and the priority suggested by the calculated binding energy had same trend as the experimentally determined IC₅₀ values. In this study of Tie-2 kinase inhibitor design three compounds, denoted as compounds rA1, rA2, and rA3 of the nine LeadOp+R generated compounds, were selected for further investigation. For these three compounds we found detailed synthetic route information¹⁶ and inhibition potency in the literature. These three compound rA1-rA3, have a higher potency than the query compound rA and the suggested priority of the new compounds with the calculated binding energy have a similar IC₅₀ potency trend. Depicted representations of compounds rA1-rA3, as well as the corresponding inhibition data from the biological experiments and their predicted binding energy are provided in Table 5.

TABLE 5
Rank of the proposed LeadOp+R compounds based on the calculated binding energy,
inhibition concentration (IC₅₀) of Tie-2 from the literature.¹⁶ All proposed compounds have a
lower IC₅₀ value than the query compound and the suggested priority of the three new
compounds (out of 631) have a similar trend as the IC₅₀ potency values.

| Rank | Structure | Inhibition IC₅₀ (nM) |
|---|---|---|
| Query | rA 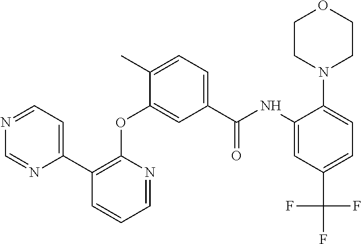 [SMILES: Cc1ccc(C(=O)Nc2cc(C(F)(F)F)ccc2N2CCOCC2)cc1Oc1ncccc1-c1ccncn1] | 399 |
| 38 | rA1 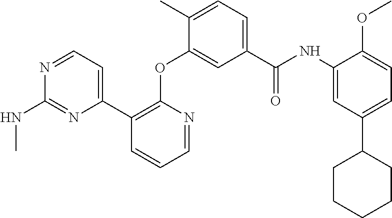 [SMILES: CNc1nccc(-c2cccnc2Oc2cc(C(=O)Nc3cc(C4CCCCC4)ccc3OC)ccc2C)n1] | 4 |
| 113 | rA2 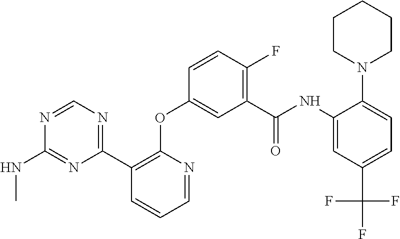 [SMILES: CNc1ncnc(-c2cccnc2Oc2ccc(F)c(C(=O)Nc3cc(C(F)(F)F)ccc3N3CCCCC3)c2)n1] | 30 |
| 292 | rA3 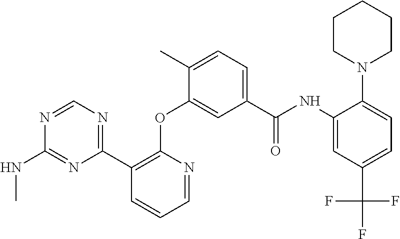 [SMILES: CNc1ncnc(-c2cccnc2Oc2cc(C(=O)Nc3cc(C(F)(F)F)ccc3N3CCCCC3)ccc2C)n1] | 108 |

Molecular dynamics simulations were performed with these three LeadOp+R generated compounds, rA1-rA3, to further analyze the ligand-protein interactions within the Tie-2 kinase active site. Following geometry optimization of the compounds with respect to Tie-2, molecular dynamics simulation studies were performed and the unique low-energy conformations of the complexes, from the final 50 ps of the MDS (50 configurations), are shown in FIG. 12b-12c.

In the generated compounds (rA1, rA2 and rA3) both amide arrangements are engaged in strong hydrogen bonds with Asp982 of the DFG-motif (first three residues of the activation loop). The pyrimidine ring in compounds rA1 and rA2 makes key hydrogen bonds with the backbone amide of the linker residue Ala905, situating the pyridine rings in alignment and within edge-to-face π-stacking distance of Phe983 of the DFG-motif; additionally, the central and terminal aryl rings overlaid with only slight differences in orientation for compounds rA1, rA2 and rA3. The additional hydrogen bonding formed between the methoxy group of compound rA1 and residue Asp982, while the CF₃-groups is placed in essentially the same location within the EHP for compounds rA2 and rA3. These optimized results indicate the hydrogen-bonding and hydrophobic interactions are important for ligands binding to and inhibiting Tie-2, as previously reported (Hodous, B. L.; Geuns-Meyer, S. D.; Hughes, P. E.; Albrecht, B. K.; Bellon, S.; Bready, J.; Caenepeel, S.; Cee, V. J.; Chaffee, S. C.; Coxon, A.; Emery, M.; Fretland, J.; Gallant, P.; Gu, Y; Hoffman, D.; Johnson, R. E.; Kendall, R.; Kim, J. L.; Long, A. M.; Morrison, M.; Olivieri, P. R.; Patel, V. F.; Polyerino, A.; Rose, P.; Tempest, P.; Wang, L.; Whittington, D. A.; Zhao, H. J. Med. Chem. 2007, 50, 611.).

### Synthetic Routes Suggested by LeadOp+R

For Tie-2 kinase inhibitors, favorable interactions occur between the ligand and the specific receptor residues Glu 872, Asp 982, Phe983, Ala905, and Glu903 (see FIG. 12a). In this example, these interactions are selected as preferred inhibitor-receptor interactions for LeadOp+R to optimize based on the provided query molecule in a selective and systematic process. Experimental synthetic routes from the literature (Hodous, B. L.; Geuns-Meyer, S. D.; Hughes, P. E.; Albrecht, B. K; Bellon, S.; Bready, J.; Caenepeel, S.; Cee, V. J.; Chaffee, S. C.; Coxon, A.; Emery, M.; Fretland, J.; Gallant, P.; Gu, Y; Hoffman, D.; Johnson, R. E.; Kendall, R.; Kim, J. L.; Long, A. M.; Morrison, M.; Olivieri, P. R.; Patel, V. F.; Polyerino, A.; Rose, P.; Tempest, P.; Wang, L.; Whittington, D. A.; Zhao, H. J. Med. Chem. 2007, 50, 611) (FIGS. 11a, 12a, and 13a) and the reaction routes suggested by LeadOp+R (FIGS. 11b, 12b, and 13b) to generate compound rA1, rA2 and rA3 are summarized below to demonstrate how LeadOp+R can suggest the synthetic reaction routes that are similar to those proposed by organic and medicinal chemists. Matched reaction rules are listed to the right of FIGS. 11c-13c with details of each synthetic step identified by LeadOp+R, for each product, described below.

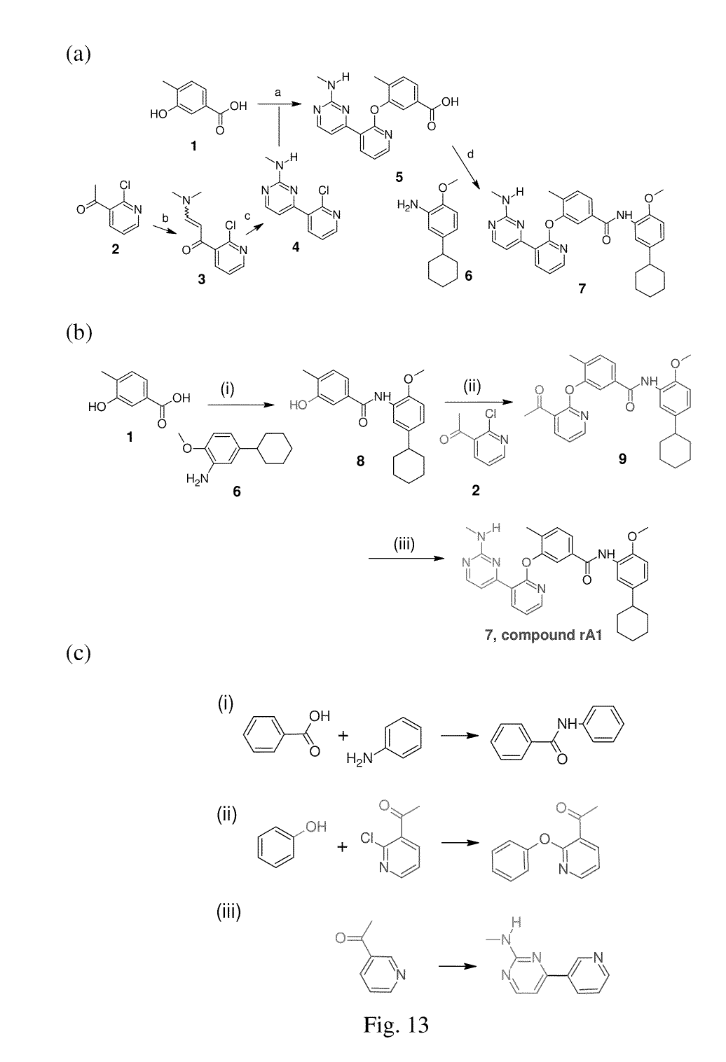

FIG. 13a illustrates the experimental reactions required to synthesize compound rA1 (compound 7) by reacting 5 (which was generated through transforming 2 into 4) followed by reacting with 1 with 6. To compare LeadOp+R's suggested virtual synthesis of compound rA1 to proven synthetic routes, we compared the key reaction rules from experimental synthetic steps in the literature (Hodous, B. L.; Geuns-Meyer, S. D.; Hughes, P. E.; Albrecht, B. K.; Bellon, S.; Bready, J.; Caenepeel, S.; Cee, V. J.; Chaffee, S. C.; Coxon, A.; Emery, M.; Fretland, J.; Gallant, P.; Gu, Y.; Hoffman, D.; Johnson, R. E.; Kendall, R.; Kim, J. L.; Long, A. M.; Morrison, M.; Olivieri, P. R.; Patel, V. F.; Polyerino, A.; Rose, P.; Tempest, P.; Wang, L.; Whittington, D. A.; Zhao, H. J. Med. Chem. 2007, 50, 611).

FIG. 13b shows the LeadOp+R suggested synthetic routes to generate compound rA1 using the selected and preferred inhibitor-receptor interactions that allowed LeadOp+R to selectively and systematically optimize the query molecule. Initially, compound 1 was identified as the first reactant by searching all building blocks with the preserved fragment. LeadOp+R then proceed to produce product 8 by coupling 1 with 6 with the reaction rule (i) that conserves the preferred interaction with Glu872 specified. The reaction rule suggested by LeadOp+R matched the synthetic steps in the literature that forms compound 7 by combining compound 5 and fragment 6. Next, product 8 was considered as the reactant to interact with compound 2 to generate product 9; by growing molecules with preferred interaction towards Phe983. The second reaction rule (ii) suggested by LeadOp+R lead to product 9 that matched the same synthetic steps as those in the literature to synthesize compound 5 by reacting 1 with 4. It is interesting to note that at this step, the structure marked in red is the current structure 9 is the same partial structure highlighted in red within the final product 7 (compound rA1) in the experimental synthesis. LeadOp+R continued the recursive optimization towards the cavity near Phe983 and Ala905 to transform 9 to 7 (compound rA1) with the third reaction rule, FIG. 4c. This reaction route suggested by LeadOp+R also matches the experimental synthetic route in the literature to transform 2 into 4. To this end, LeadOp+R has successfully optimized the query compound rA to compound rA1 and suggested corresponding synthetic routes. In this example, we demonstrated how LeadOp+R controls the synthetic flow by extending the molecules with preferred interactions, available building blocks and associated reactions rules to reach fragment based optimization and synthetic accessible. Thus, the sequence of reactions to “grow” molecules may not be the same as those verified in experimental synthesis.

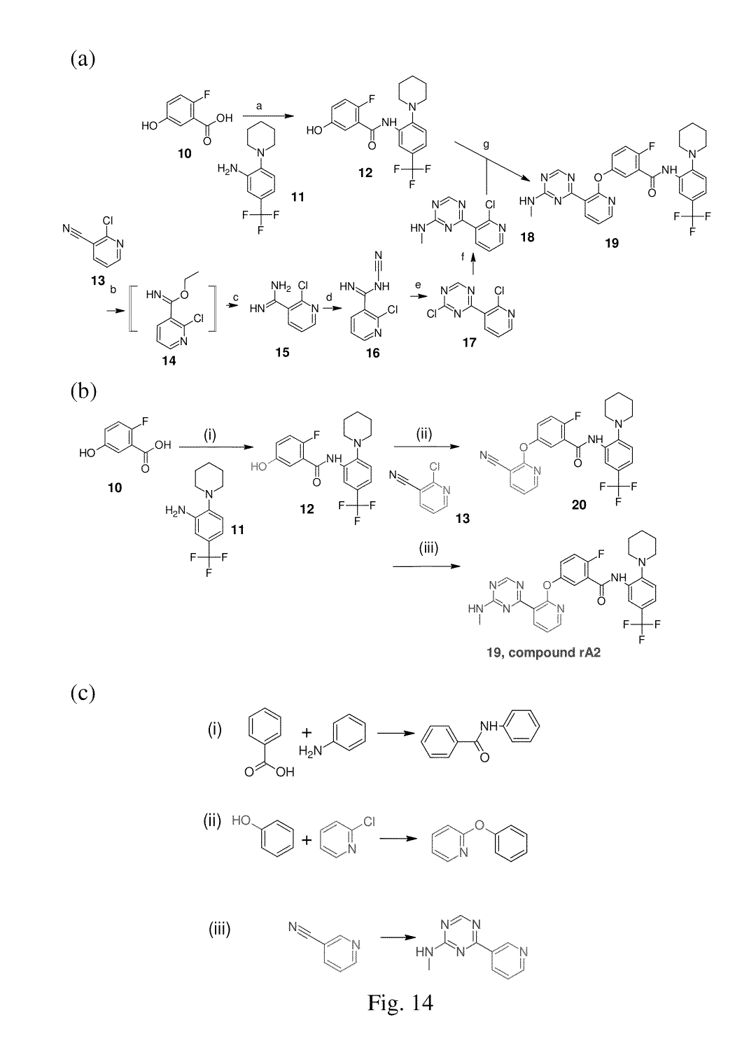

FIG. 14a shows the experimental reaction to synthesize compound rA2 (compound 19) by reacting 18 (which was generated through the transformation of 13 to 18) with 12 (which was generated through the reaction of 10 with 11). To compare the LeadOp+R suggested virtual synthesis route for compound rA2 with the experimental synthetic route, we compared the key reaction rules from the experimental synthetic steps in the literature with the LeadOp+R suggested synthetic routes.

FIG. 14b shows the LeadOp+R suggested synthetic routes for compound rA2, using the selected and preferred inhibitor-receptor interactions to optimize the query molecule in a selective and systematic manner Initially, a hydroxy benzoic acid of 10 was identified as the first reactant by searching all building blocks with the preserved fragment. Leadop+R then proceed to suggest product 12 by reacting 10 with 11 via the first reaction rule (i) that preserves the ligand's interaction with Glu972 of the active site. The reaction rule suggested by LeadOp+R matched the synthetic steps in the literature that forms compound 12 from compounds 10 and 11. Next product 12 was considered as the reactant to react with compound 13 to generate product 20, by growing molecules with preferred interaction towards Phe983. The second reaction rule (ii) generates product 20 and the reaction route suggested by LeadOp+R matches the synthetic steps in the literature to synthesize compound 19 through the reaction of 12 with 18. LeadOp+R's recursive optimization continues toward the cavity near Phe983 and Ala905 to transform 20 to 19 (compound rA2) via the third reaction rule (iii), FIG. 14c. This reaction route suggested by LeadOp+R also matched the experimental synthetic step in the literature to transform compound 13 to 18.

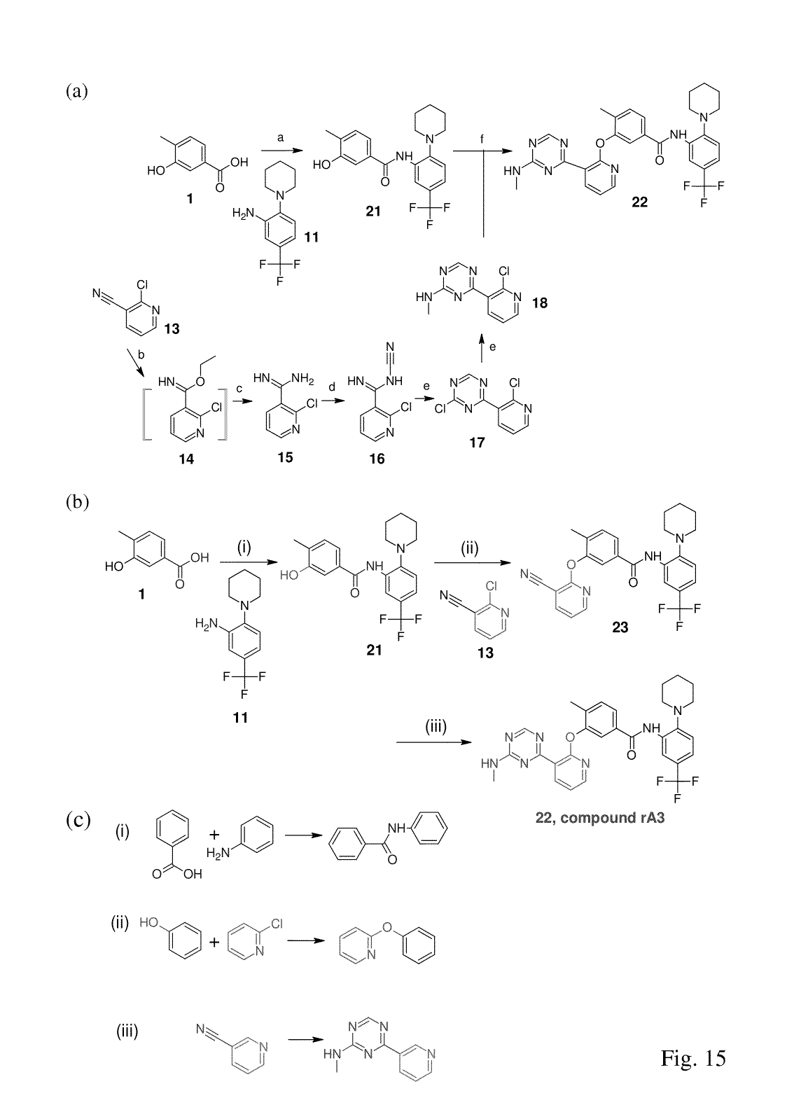

FIG. 15a shows the experimental reaction to synthesize compound rA3 (compound 22) by reacting 21 (which was generated through the reaction of 1 with 11) with 18 (which was synthesized from 13). To compare LeadOp+R's suggested synthesis route for compound rA3 with the experimental synthetic routes, we compared the key reaction rules from experimental the synthetic steps in the literature with the LeadOp+R suggested synthetic routes.

FIG. 15b depicts the LeadOp+R suggested synthetic routes to generate compound rA3, using the selected and preferred inhibitor-receptor interactions to optimize the query molecule. Initially, compound 1, a hydroxybenzoic acid, was identified as the first reactant by searching all building blocks with the preserved fragment indicated in red, FIG. 15b. LeadOp+R then proceeded to produce compound 21 by reacting 1 with 11 via the first reaction rule (i) directing the growth of the compound (inhibitor) towards the preferred ligand interaction with Glu972. The reaction rule suggested by LeadOp+R matched the synthetic steps in the art that forms compound 21 via the transformation of compound 1 with fragment 11. Next, product 21 was reacted with compound 13 to generate product 23, growing the transformed molecule towards Phe983. The second reaction rule (ii) generated product 22 as suggested by LeadOp+R matches the same synthetic steps as those in the literature to synthesize compound 22 through the reaction of compound 21 with fragment 18. The recursive optimization of the initial query compound towards the cavity near Phe983 and Ala905 by LeadOp+R transformed compound 23 to 22 (compound rA3) with the third reaction rule (iii) as illustrated in FIG. 15c. This reaction rule, suggested by LeadOp+R, also matches the experimental synthetic step in the literature to transform 13 to 18.

LeadOp+R has successfully optimized the query compound rA to compounds rA1, rA2, and rA3 with synthetic routes that match experimental synthetic routes for each compound. Through the systematic synthesis and constant evaluation of intermediate products via group efficiency, LeadOp+R searched each product and discovered higher binding inhibitors. Increased hydrophobic interactions between compound rA1 and the receptor were observed between the compound's aromatic group that resides in the EHP pocket (FIG. 12b) and the methylpyrimidine, this corresponds to the experimental results and this compound exhibits stronger inhibitor potency than compounds rA2 and rA3.

In the example of Tie-2 inhibitor design, LeadOp+R demonstrates its ability to control the synthetic flow by extending the query molecules to optimize the preferred ligand-receptor interactions while using the available building blocks and associated reactions rules to find the most feasible synthetic accessibility.

### Example 4

### LeadOp+R for Human 5-Lipoxygenase Inhibitor

Structure-Based Lead Optimization with Synthetic Routes

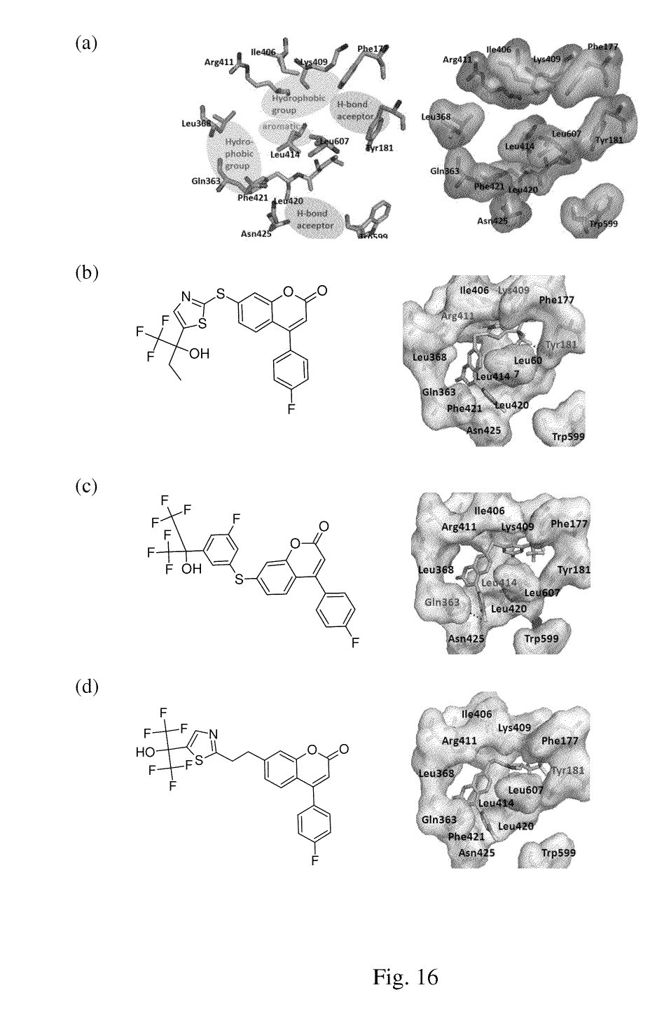

The human 5-Lipoxygenase (5-LOX) enzyme with the well known 5-LOX inhibitors was selected as the second LeadOp+R test case. To design better 5-LOX inhibitors, structural insight of the 5-LOX active site and its associated interactions with ligands would be helpful, therefore we selected a theoretical model (comparative/homology protein structure/model) of 5-LOX (Charlier, C.; Hénichart, J.-P.; Durant, F.; Wouters, J. J. Med. Chem. 2005, 49, 186) that has good agreement with mutagenesis studies (Hammarberg, T.; Zhang, Y. Y.; Lind, B.; Radmark, O.; Samuelsson, B. Eur. J. Biochem. 1995, 230, 401; Schwarz, K.; Walther, M.; Anton, M.; Gerth, C.; Feussner, I.; Kuhn, H. J. Biol. Chem. 2001, 276, 773). The proposed active site of 5-LOX forms a deep and bent cleft (channel) that extends from Phe177 and Tyr181 at the top of the cleft to the Trp599 and Leu420 amino acid residues at the bottom of the cleft (shown in FIG. 16a). Most of the residues lining the cleft are hydrophobic with several key polar residues (Gln363, Asn425, Gln557, Ser608, and Arg411) distributed along the channel with the ability to interact with the ligand during the binding process. A small side pocket off of the main channel is composed of hydrophobic residues (Phe421, Gln363, and Lue368) and it is postulated that the lipophilic interactions between the ligand and receptor may enhance activity. The purported major pharmacophore interactions needed for a ligand to bind to 5-LOX includes: (i) two hydrophobic groups, (ii) a hydrogen bond acceptor, (iii) an aromatic ring, and (iv) two secondary interactions. The two secondary interactions are between the ligand and an acidic moiety (amino acid residue) and a hydrogen bond acceptor within the binding pocket of the receptor. The hydrogen bond acceptor of the ligand most likely interacts with the key anchoring points of the receptor (Tyr181, Asn425, and Arg411) to form hydrogen bonds, while Leu414 and Phe421 form a hydrophobic interaction between the ligand and the binding cavity (Charlier, C.; Hénichart, J.-P.; Durant, F.; Wouters, J. J. Med. Chem. 2005, 49, 186).

The 5-LOX inhibitor, compound 7 in the literature (Ducharme, Y.; Blouin, M.; Brideau, C.; Chateauneuf A.; Gareau, Y.; Grimm, E. L.; Juteau, H.; Laliberte, S.; MacKay, B.; Masse, F.; Ouellet, M.; Salem, M.; Styhler, A.; Friesen, R. W. ACS Med. Chem. Lett. 2010, 1, 170), was selected as our initial query molecule (denoted as compound rB in this study), which had a biologically determined IC₅₀ value of 145 nM. Compound rB was docked into the 5-LOX computationally derived binding site and the lowest energy conformation was submitted to LeadOp+R. This selected pose (conformation) possesses similar ligand-receptor interactions as previously reported (Ducharme, Y.; Blouin, M.; Brideau, C.; Chateauneuf, A.; Gareau, Y.; Grimm, E. L.; Juteau, H.; Laliberte, S.; MacKay, B.; Masse, F.; Ouellet, M.; Salem, M.; Styhler, A.; Friesen, R. W. ACS Med. Chem. Lett. 2010, 1, 170). The oxochromen ring favorably interacts with the hydrophobic residue Leu414 (CH-π interaction) in the middle of the cavity, while the fluoro phenyl group extends into the hydrogen-bond acceptor region in the lower cleft of the active site. The docked conformation of compound rB was selected as the reference inhibitor with the oxochromen ring serving as the template structure.

To evaluate our algorithm, we compared all of the LeadOp+R generated compounds for 5-LOX to the analogs described in the literature and found that six of the LeadOp+R proposed compounds have been synthesized and their biological activities measured (Schwarz, K.; Walther, M.; Anton, M.; Gerth, C.; Feussner, I.; Kuhn, H. J. Biol. Chem. 2001, 276, 773). The inclusive synthesis of products at each steps combined with systematically examining the interactions of the proposed compounds with the receptor generated six compounds that have more potent IC₅₀ values than the original compound (compound rB). All the LeadOp+R generated compounds were energy minimized within the active site of 5-LOX and then ranked based on the predicted binding energy of the complex and the suggested priority has the same trend as the IC₅₀ potency values from the experimental study (Schwarz, K; Walther, M.; Anton, M.; Gerth, C.; Feussner, I.; Kuhn, H. J. Biol. Chem. 2001, 276, 773). In this study of 5-LOX inhibitor design, three compounds (denoted as compounds rB 1, rB2, and rB3) of the nine LeadOp+R generated compounds, were selected for further investigation. For these three compounds detailed synthetic information (Ducharme, Y.; Blouin, M.; Brideau, C.; Chateauneuf, A.; Gareau, Y; Grimm, E. L.; Juteau, H.; Laliberte, S.; MacKay, B.; Masse, F.; Ouellet, M.; Salem, M.; Styhler, A.; Friesen, R. W. ACS Med. Chem. Lett. 2010, 1, 170) and inhibition potency is available from the literature (Ducharme, Y.; Blouin, M.; Brideau, C.; Chateauneuf, A.; Gareau, Y.; Grimm, E. L.; Juteau, H.; Laliberte, S.; MacKay, B.; Masse, F.; Ouellet, M.; Salem, M.; Styhler, A.; Friesen, R. W. ACS Med. Chem. Lett. 2010, 1, 170). Additionally, these three compound rB1, rB2, and rB3 have a higher potency than the query compound rB and their suggested priority, based on predicted binding energy, as well as a similar IC₅₀ trend. Depicted representations of the compounds rB1, rB2, and rB3, the corresponding inhibition data from the biological experiments, and their predicted binding energy are listed in Table 2.

TABLE 6
Rank of the proposed LeadOp+R compounds based on the calculated binding energy,
inhibition conctration (IC₅₀) of 5-LOX from the literature. All proposed compounds have a
higher IC₅₀ value than the query compound and the suggested priority of the three new
compounds (out of 419) have a similar trend as the IC₅₀ potency values

| Rank | Structure | Inhibition IC₅₀ (nM) |
|---|---|---|
| Query | rB 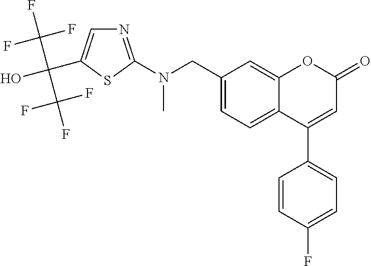 [SMILES: CN(Cc1ccc2c(-c3ccc(F)cc3)cc(=O)oc2c1)c1ncc(C(O)(C(F)(F)F)C(F)(F)F)s1] | 145 |
| 52 | rB1 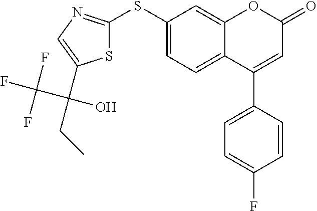 [SMILES: CCC(O)(c1cnc(Sc2ccc3c(-c4ccc(F)cc4)cc(=O)oc3c2)s1)C(F)(F)F] | 7 ± 2 |
| 107 | rB2 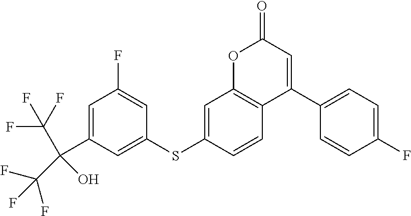 [SMILES: O=c1cc(-c2ccc(F)cc2)c2ccc(Sc3cc(F)cc(C(O)(C(F)(F)F)C(F)(F)F)c3)cc2o1] | 27 ± 16 |
| 297 | rB3 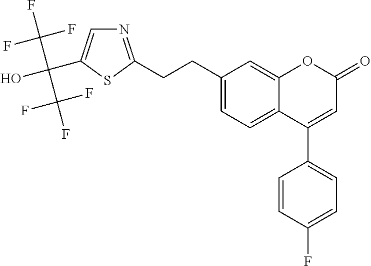 [SMILES: O=c1cc(-c2ccc(F)cc2)c2ccc(CCc3ncc(C(O)(C(F)(F)F)C(F)(F)F)s3)cc2o1] | 64 ± 3 |

Molecular dynamics simulation studies were performed with the final poses of compounds rB1, rB2, and rB3 with respect to 5-LOX. The unique low-energy conformations of the complexes, from the last 50 ps of the MDS (50 configurations), are shown in FIG. 16b-16c.

The interactions of compounds rB 1, rB2, and rB3 all reside within the hydrophobic pocket and contain the hydrogen bonding interactions between the oxygen or nitrogen atoms of the thiazol group with Lys409 and Tyr181. For compounds rB1 and B3, the fluoro group extends to the hydrogen-bond acceptor in the upper domain of the active site and interacts with Lys409. In addition, the oxochromen ring is in close proximity to Leu414 and is potentially an important CH-π contact as indicated in the art. Also, the thiazole structure of compound rB 1 interacts with the 5-LOX hydrophobic residues Leu420 and Leu607 and it has been suggested that these interactions improve ligand binding via complementary hydrophobic interaction between the ligand and receptor. Additional favorable interactions occur between the fluoro group and residues Lys409, Arg411 and Tyr181. These contributions to the ligand-protein binding probably accounts for compound rB1's better inhibition compared to compounds rB, rB2, and rB3. These optimized results indicate that hydrogen bonding and hydrophobic interactions are important for ligands binding to and inhibiting 5-LOX as previous report (Hodous, B. L.; Geuns-Meyer, S. D.; Hughes, P. E.; Albrecht, B. K; Bellon, S.; Bready, J.; Caenepeel, S.; Cee, V. J.; Chaffee, S. C.; Coxon, A.; Emery, M.; Fretland, J.; Gallant, P.; Gu, Y.; Hoffman, D.; Johnson, R. E.; Kendall, R.; Kim, J. L.; Long, A. M.; Morrison, M.; Olivieri, P. R.; Patel, V. F.; Polyerino, A.; Rose, P.; Tempest, P.; Wang, L.; Whittington, D. A.; Zhao, H. J. Med. Chem. 2007, 50, 611).

### Synthetic Routes Suggested by LeadOp+R

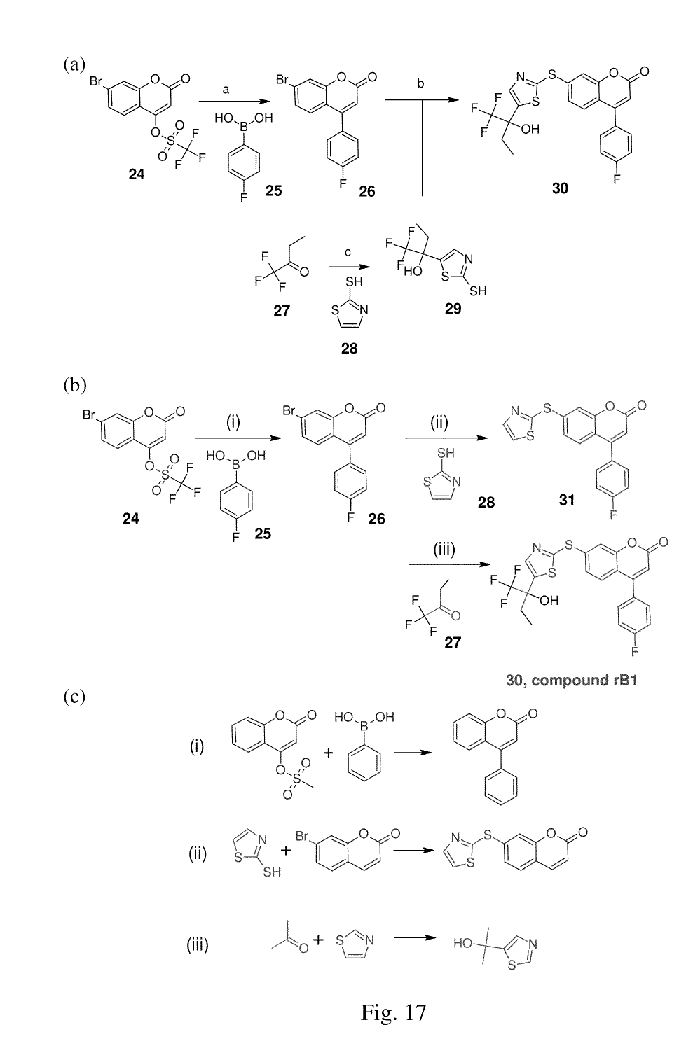

The favorable interactions between inhibitors and 5-LOX, as stated in the literature, are two Hydrogen-bond acceptor interactions within the binding pockets (including ligand interactions with Asn425 and Tyr181) and two hydrophobic interaction pockets (including ligand interactions with Leu368, Gln363, Phe421, Arg411, Ile406, Lys409, and Phe177) and an aromatic interactions (between the ligand and residues Leu414 and Leu607). In this example, ligand interactions with Asn425, Leu414, Leu607, and Tyr181 are indicated as “preferred” inhibitor-receptor interactions for LeadOp+R to selectively and systematically optimize. Experimental synthetic routes from the literature (Schwarz, K.; Walther, M.; Anton, M.; Gerth, C.; Feussner, I.; Kuhn, H. J. Biol. Chem. 2001, 276, 773) (FIGS. 17a, 18a, and 19a) and the synthetic reaction routes suggested by LeadOp+R (FIGS. 17b, 18b, and 19b) to generate compound rB1, rB2 and rB3 are summarized below. To demonstrate LeadOp+R's ability to suggest reaction routes similar, or exactly the same as those, to those proposed and executed by synthetic chemists, the matched reaction rules are listed to the right of FIG. 15c-17c. Details of each synthetic step, identified by LeadOp+R for each product (proposed compounds/inhibitor), are described below.

FIG. 17a shows the experimental reaction route (Schwarz, K; Walther, M.; Anton, M.; Gerth, C.; Feussner, I.; Kuhn, H. J. Biol. Chem. 2001, 276, 773) to synthesize compound rB 1 (compound 30) by reacting compound 26 (which was generated through the reaction of 24 with 25) with 29 (which was generated through the reaction of 27 with 28). To compare the LeadOp+R suggested synthesis with the experimental synthetic route for compound rB1, we compared the key reaction rules for the experimental synthetic steps in the literature with those suggested by LeadOp+R.

FIG. 17b shows the LeadOp+R suggested synthetic routes to generate compound rB1 using the selected preferred inhibitor-receptor interactions. Initially, compound 24 was identified as the initial reactant by searching all the available building blocks and the preserving the molecular fragment. LeadOp+R proceeded to suggest product 26 by reacting 24 with 25 with the first reaction rule (i) suggested by LeadOp+R that “grows” the compound towards the preferred interaction of the ligand with Asn425. The reaction rule suggested by LeadOp+R matches the synthetic steps in the literature that yields compounds 26, 24 and 25. Next, product 26 was considered as the reactant to interact with compound 28 to generate product compound 31; by extending the molecule towards preferred interactions with Leu414. The second reaction rule (ii) to generate compound 31, as suggested by LeadOp+R, matches the synthetic routes presented in the literature to synthesize thioether bond in compound 30 through the reaction of 26 with 29. It should be indicated that in this step, the structure marked in red is compound 31 and it is the same as the partial structure denoted in red for the final product 30 (compound rB1) in the experimental synthesis. The recursive optimization continues via LeadOp+R towards the cavity near Ile406 and the synthesis of compound 30 (compound rB1) by reacting 31 with 27 and the third reaction rule (iii) in FIG. 17c. The LeadOp+R suggested reaction route also matches the experimental synthetic step in the literature to synthesize compound 29 through the reaction of 27 with 28. To this end, LeadOp+R has successfully optimized the query compound rB to compound rB1 and suggested feasible synthetic routes. In this example, we demonstrated LeadOp+R's controls of the synthetic flow by extending the molecules to exploit preferred interactions, available building blocks and associated reactions rules to achieve fragment based optimization and synthetic accessibility; for this reason, the sequence of steps to “grow” molecules may not be the same as the published experimental synthesis.

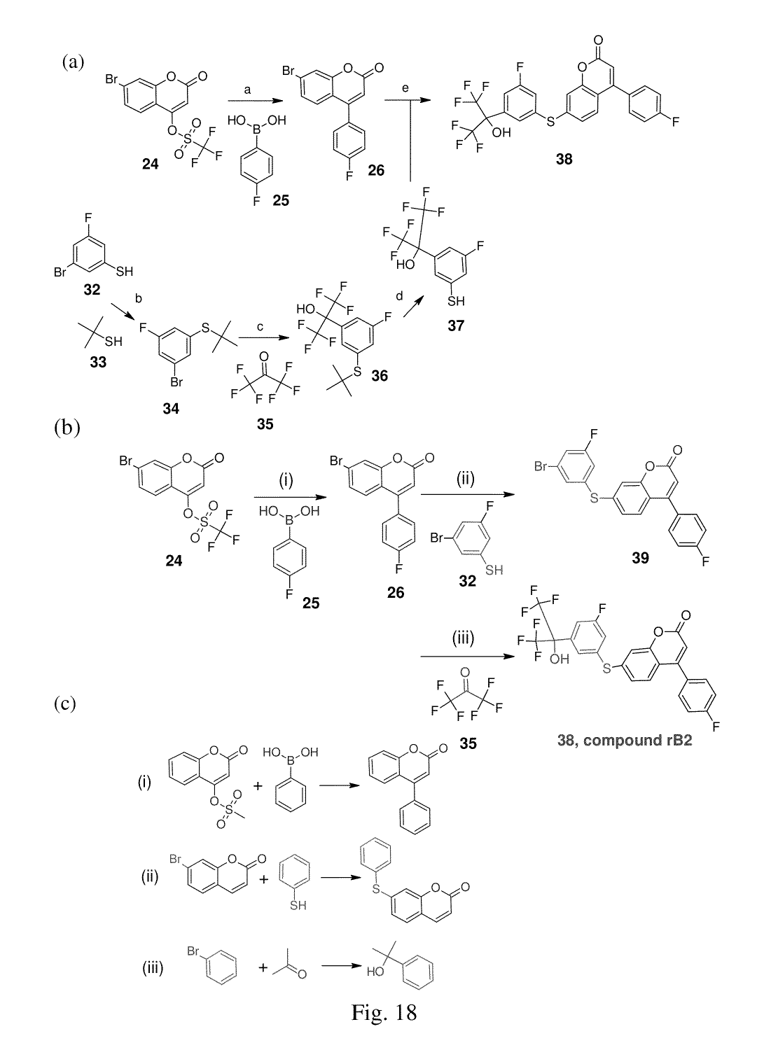

FIG. 18a depicts the experimental reaction (Schwarz, K.; Walther, M.; Anton, M.; Gerth, C.; Feussner, I.; Kuhn, H. J. Biol. Chem. 2001, 276, 773) to synthesize compound rB2 (compound 38) by reacting 26 (which was generated through the reaction of 24 with 25) with 37 (which was synthesized through a series of reaction starting with compound 32 to formed 37). To compare LeadOp+R's suggested synthesis of compound rB2 to the experimental synthetic routes, we explored the key reaction rules of the experimental synthetic steps in the literature for the proposed compound.

FIG. 18b shows the LeadOp+R suggested synthetic routes to generate compound rB2 based on the user specified preferred inhibitor-receptor interactions that LeadOp+R optimized selectively and systematically. Initially, compound 24 was identified as the first reactant by searching all building blocks with the preserved fragment. LeadOp+R then proceed to produce compound 26 by reacting 24 with 25 via the first reaction rule (i) suggested by LeadOp+R that directs the suggested compound towards the preferred interaction with Leu414. The reaction rule suggested by LeadOp+R matches the synthetic steps in the literature for the synthesis of compound 26 from compound 24 and 25. Next, product 26 was considered as the reactant to react with compound 32 to generate product 39; again by growing the molecule toward the preferred interaction with Leu414. The second reaction rule (ii) to generate product 39 suggests the same synthetic steps as the literature to synthesize compound 38 by reacting 26 and 27. The recursive optimization continues to explore the potential ligand interactions with Leu414 and Ile406 to generate compound 38 (compound rB2) by reacting 39 with 35 with the third reaction rule (iii) to synthesize compound 36 by the reaction of 34 and 35, resulting in the final product compound rB2.

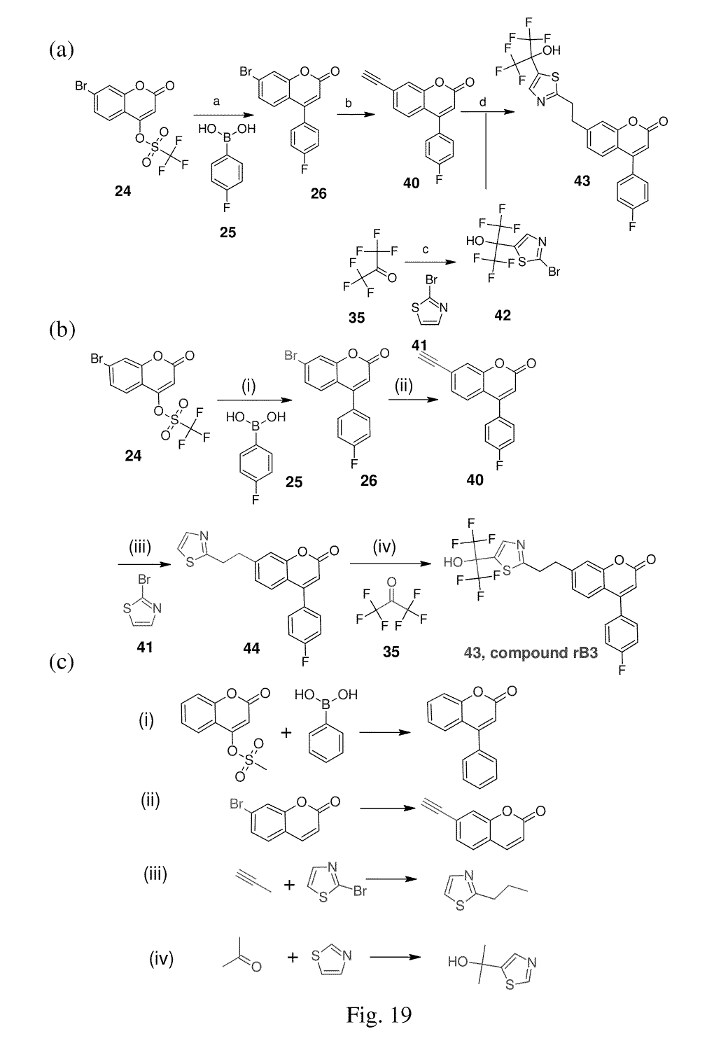

FIG. 19a shows the experimental synthesis route (Schwarz, K.; Walther, M.; Anton, M.; Gerth, C.; Feussner, I.; Kuhn, H. J. Biol. Chem. 2001, 276, 773) to synthesize compound rB3 (compound 43) by reacting 40 with 42 (which was generated through the reaction of 35 with 41). To compare the LeadOp+R suggested route to the experimental route for rB3, we look at the key reaction rules-in the literature.

FIG. 19b shows the LeadOp+R suggested synthetic routes for compound rB3 using the selected preferred inhibitor-receptor interactions. Initially, compound 24 was identified as the first reactant by searching all building blocks with the preserved fragment that is indicated in FIG. 19b as the red structure. LeadOp+R proceeded to generate compound 26 by reacting 24 with 25 via the first reaction rule (i) that was suggested by LeadOp+R. Again, this methodology directs the growth of the new ligand towards the preferred interaction; the ligand interacting with Leu414. The synthetic reactions suggested by LeadOp+R match the synthetic steps presented in the literature that forms compound 26. Next, product 26 was considered the reactant and transformed into product 40 by growing the ligand towards Ile406 of 5-LOX. The second reaction rule (ii) generates compound 40 and matches the synthetic steps discussed in the literature; compound 40 is identified as the same product that is discussed in the literature to synthesize compound 44. Continuing the recursive optimization to initiate the ligand's interaction with Ile 406 and Tyr181 results in the third reaction rule (iii), FIG. 19c, leads to compound 43. Compound 44 was identified as the reactant and reacted with 35 based on the fourth reaction rule (iv), generating compound 42 by reacting 35 with 41.

LeadOp+R has successfully optimized the query compound rB into compounds rB 1, rB2, and rB3 and has suggested corresponding synthetic route for each compound. Through systematic-synthesis and evaluation of intermediates using group efficiency, LeadOp+R searches for “products” with higher calculated binding affinities and improved interactions with the receptor. The more hydrogen-bonding interactions between compound rB1's oxygen or nitrogen atoms of the thiazol group and the receptor (shown in FIG. 14b) corresponds to the experimental results of stronger inhibitor potency then the proposed compounds rB2 and rB3. In the example of 5-LOX inhibitor design, we demonstrate LeadOp+R's ability to controls the synthetic flow by extending the ligands with preferred interactions, available building blocks and associated reactions rules.

What is claimed is:

1. A method for optimizing a lead compound, comprising:
(i) docking a lead compound into a target molecule to obtain the information of the lead compound and its binding site;
(ii) decomposing the docked lead compound of (i) to form fragments;
(iii) evaluating the fragments of (ii) on the basis of group efficiency or synthetic accessibility to determine the fragments to be preserved and replaced; and
(iv) reassembling the preserved fragments and the replaced fragments of (iii) to construct the optimized lead compound library.

2. The method of claim 1, wherein the decomposition in (ii) is performed by chemical or user-defined rules

3. A method for optimizing a lead compound, comprising:
(a) docking a lead compound into a target molecule to obtain the information of the lead compound and its binding site;
(b) decomposing the docked lead compound to form fragments;
(c) evaluating each fragment of (b) with the degree of interaction based on group efficiency and then ranking them;
(d) searching for a library to obtain of potential replacement fragments and predocking each fragment into the binding site of the target molecule to obtain the substitution fragments;
(e) preserving the top 50% fragments of the ranked fragments of (c) and replacing reminder fragments with the substitution fragments of (d); and
(f) reassembling the preserved fragments and the replaced fragments to construct the optimized lead compound library.

4. The method of claim 3, which after step (b), further comprises (b1) determining lead compound-target molecule interaction directions to be optimized.

5. The method of claim 3, wherein the target molecule is a biomolecule, part of a biomolecule, compound of one or more biomolecules or other bioreactive agent and the lead compound has a molecular weight less than 500 kDa.

6. The method of claim 3, wherein the decomposition of (b) is performed by chemical or user-defined rules

7. The method of claim 3, wherein in the evaluation of (c), the interaction may be a physical or chemical interaction of one or more molecular subsets with itself (intramolecular) or other molecular subsets (intermolecular).

8. The method of claim 3, wherein in the evaluation of (c), the interaction may be either enthalpic or entropic interaction.

9. The method of claim 3, wherein in the predocking of step (d), the fragments are predocked into the binding site of the target molecule by calculating the desolvation energy to obtain the replacement fragments.

10. The method of claim 3, wherein in the predocking of step (d), acceptable bond distance(s) and angle(s) between the fragments and the original lead compounds attachment points are used to determine if the docked fragment should be a possible replacement.

11. The method of claim 3, wherein in step (e), about top 40% fragments of the ranked fragments are preserved.

12. The method of claim 3, wherein in step (e), about top 30% fragments of the ranked fragments are preserved.

13. The method of claim 3, wherein in step (e), about top 20% ragments of the ranked fragments are preserved.

14. The method of claim 3, which further comprises trimming the optimized lead compound library to remove those that violate Lipinski's rules-of-five.

15. The method of claim 14, wherein the compounds with (i) four or more double bonds (excluding aromatic bonds) or triple bonds with no more than three of each type or (ii) 11 or more triple bond are removed.

16. The method of claim 14, which further comprises performing molecular dynamics simulations.

17. A system for lead optimization, comprising (i) a docking unit for docking a lead compound into a target molecule to obtain the information of the lead compound and its binding site; (ii) a decomposition unit for decomposing the docked lead compound to form fragments; (iii) an evaluation unit for evaluating each fragment of (ii) with the degree of interaction based on group efficiency and then ranking them; (iv) a predocking unit for searching for a library to obtain of potential replacement fragments and predocking each fragment into the binding site of the target molecule to obtain the replacement fragments; (v) a preserving and replacing unit for preserving the top 50% fragments of the ranked fragments of (iii) and replacing reminder fragments with the substitution fragments of (iv); and (vi) a reassembling unit for reassembling the preserved fragments and the replaced fragments to construct the optimized lead compound.

18. A method for lead optimization with synthetic accessibility, comprises:
(A) docking a lead compound into a target molecule to obtain the information of the lead compound and its binding site;
(B) decomposing the docked lead compound to form fragments and determining fragments to be preserved;
(C) identifying the first building block containing preserved fragments of the lead compound,
(D) identifying reactants and searching for the reaction rules for each reactants identified from a reaction rule library;
(E) reacting reactants to generate reaction products based on their reaction rules; and
(F) evaluating the conformations of each products of each reaction and selecting the conformers to react with the first building block to grow molecules so that an optimized lead compound library is constructed.

19. The method of claim 18, which after step (B), further comprises (B1) determining lead compound-target molecule interaction directions to be optimized.

20. The method of claim 18, wherein the target molecule is a biomolecule, part of a biomolecule, compound of one or more biomolecules or other bioreactive agent and the lead compound has a molecular weight less than 500 kDa.

21. The method of claim 18, wherein the decomposition of (b) is performed by chemical or user-defined rules.

22. The method of claim 18, wherein in the identification of (c), the first building block is identified by a preserved space defined by the volume occupied by a preserved fragment.

23. The method of claim 18, wherein in the identification of (d), the reaction rule library is constructed by collecting chemical reactions, building blocks, and reaction rules with reactant moieties and product moieties of each reaction.

24. The method of claim 18, wherein in the identification of (d), the reactants are identified by preserving a fragment space that is defined by the volume occupied by a fragment of the lead compound.

25. The method of claim 18, wherein in the evaluation of (F), the conformers are selected by having stronger binding towards the specified lead compound-target molecule interactions with less heavy atoms.

26. The method of claim 18, which further comprises trimming the optimized lead compound library to remove those that violate Lipinski's rules-of-five.

27. The method of claim 26, wherein the compounds with (i) four or more double bonds (excluding aromatic bonds) or triple bonds with no more than three of each type or (ii) 11 or more triple bond are removed.

28. The method of claim 26, which further comprises performing molecular dynamics simulations.

29. A system for lead optimization with synthetic accessibility, comprising (i) a docking unit for docking a lead compound into a target molecule to obtain the information of the lead compound and its binding site; (ii) a decomposition unit for decomposing the docked lead compound to form fragments and determining fragments to be preserved; (iii) a first identification unit for identifying the first building block containing preserved fragments of the lead compound; (iv) a second identification unit for identifying reactants and searching for the reaction rules for each reactants identified from a reaction rule library; (v) an reaction unit for reacting reactants to generate reaction products based on their reaction rules; and (vi) an evaluation unit for evaluating the conformations of each products of each reaction and selecting the conformers to react with the first building block to grow molecules so that a optimized lead compound library is constructed.
